(19) United States
(12) Patent Application Publication
(10) Pub. No.: US 2026/0315820 A1
(43) Pub. Date: Oct. 15, 2026

(54) THERAPEUTIC HAIRPIN DEVICE

(71) Applicant: Shenzhen Oren Medical Technology Co., Ltd., Shenzhen (CN)

(72) Inventors: Baihui Ou, Shenzhen (CN); Alain Dijkstra, Amstelveen (NL); Bailing Ou, Shenzhen (CN); Su Kaifang, Shenzhen (CN)

(73) Assignee: Shenzhen Oren Medical Technology Co., Ltd., Shenzhen (CN)

(21) Appl. No.: 19/466,916

(22) Filed: Feb. 2, 2026

(30) Foreign Application Priority Data
Feb. 12, 2025 (CN) 2025202266183

(51) Int. Cl. A61N 5/06; A45D 8/04; A45D 34/04; A61H 15/00; A61H 15/02

(52) U.S. Cl. CPC A61N 5/0617; A45D 8/04; A45D 34/04; A61H 15/0092; A61H 15/02; A61H 2201/10; A61N 2005/0626; A61N 2005/063; A61N 2005/0644; A61N 2005/0647

(57) ABSTRACT

A phototherapy hairpin comprising a hairpin body with a head and a rod. The head includes a mounting cavity, a lamp board configured to emit therapeutic light, and a light-transmitting shell covering a light emission hole, wherein the light-transmitting shell contacts human skin to provide phototherapy and massage. The rod is configured to secure a hair bun and includes light-emitting units oriented toward the scalp to provide scalp phototherapy. One or more sensors detect whether the device is secured in hair or held in hand, and a control board automatically activates the appropriate phototherapy unit based on the detected mode. The distal tip may include a storage chamber for dispensing therapeutic substances or a second stimulation element. The device integrates phototherapy, massage, and optional thermal, magnetic, or microcurrent stimulation in a compact, wearable form.

### TECHNICAL FIELD

The present invention relates to the field of personal care and therapeutic devices. More particularly, it pertains to a handheld phototherapy hairpin configured to provide one or more therapies to a user.

### BACKGROUND OF THE INVENTION

Phototherapy, also known as light therapy, is a non-invasive treatment modality that uses specific wavelengths of light to treat various skin and scalp conditions. Red light at wavelengths of approximately 630 to 660 nanometers promotes cellular metabolism, collagen production, and wound healing. Blue light at wavelengths of approximately 415 nanometers provides antibacterial action effective against acne-causing bacteria. Near-infrared light at wavelengths of approximately 800 to 880 nanometers penetrates deeper into tissue to stimulate hair follicles and improve circulation. These phototherapy modalities have gained acceptance for treating conditions including acne, skin aging, hair loss, and scalp disorders.

Existing phototherapy devices for scalp and hair treatment typically take the form of helmets, caps, headbands, or combs that house arrays of light-emitting diodes. While these devices can deliver therapeutic light to the scalp, they suffer from significant practical limitations. Helmets and caps are bulky, heavy, and conspicuous, making them unsuitable for use outside the home. Users wearing such devices in public face social stigma, which reduces treatment compliance and limits the therapeutic benefit. These devices are dedicated single-purpose instruments that serve no function other than therapy, requiring users to set aside specific time for treatment sessions rather than integrating therapy into daily activities.

Existing phototherapy devices for facial and skin treatment typically take the form of handheld wands, panels, or probes. These devices are designed for localized application to the face, neck, or body, but are not configured for scalp treatment. Users who desire both scalp therapy for hair growth and facial therapy for skin rejuvenation must therefore purchase, maintain, and carry multiple separate devices. This increases cost, complexity, and inconvenience, and reduces the likelihood that users will maintain consistent treatment regimens for both applications.

Conventional handheld beauty devices that combine multiple functions, such as massage instruments with jade rollers, LED lights, spray nozzles, and heating elements, suffer from complex designs with poor functional integration. Many such devices have fixed, non-modular construction that does not permit disassembly for cleaning or replacement of components. These devices typically provide only a single treatment surface at the head, limiting the areas that can be treated and requiring users to reposition the device frequently. Furthermore, these devices require manual selection of operating modes, placing a burden on users to remember to switch modes when changing from one treatment application to another.

Traditional hair accessories such as hairpins, hair sticks, and bun pins serve a purely mechanical function of securing hair in place. These accessories have no therapeutic capability and provide no benefit beyond their aesthetic function. Users who wish to receive phototherapy while going about daily activities have no option but to do so discreetly, as existing phototherapy devices are not designed to be worn as normal accessories. There is no known device that combines the aesthetic function of a hairpin with therapeutic functions such as phototherapy, massage, thermal therapy, or electrical stimulation.

Existing devices also lack features that would enhance convenience and treatment efficacy. For example, conventional phototherapy devices do not include automatic sensing to detect the usage context and activate appropriate treatment modalities without manual intervention. Conventional devices do not integrate dispensing mechanisms for topical substances such as serums or medications that could act synergistically with phototherapy. Conventional devices lack protective covers to maintain the hygiene of treatment surfaces when the device is stored or worn in contact with hair. Conventional devices do not provide stimulation elements at multiple locations, such as both the head and the tip of a handle portion, to enable multi-point treatment.

Accordingly, there exists a need for a phototherapy device that addresses these limitations by combining the mechanical function of a hairpin with therapeutic functions in a single, compact, wearable device. Such a device should be capable of delivering phototherapy to the scalp when worn in the hair and to the face or body when held in the hand, with automatic detection of the usage mode and corresponding activation of appropriate treatment elements. The device should have a modular, detachable construction that facilitates cleaning, maintenance, and component replacement. The device should integrate multiple therapeutic modalities coordinated by a single control system, and should include features such as a protective cover, a dispensing mechanism for topical substances, and stimulation elements at multiple locations to provide comprehensive, convenient, and effective treatment.

### OBJECTS OF THE INVENTION

Some objects of the invention are as follows:

An object of the present invention is to provide a phototherapy hairpin that functions both as a hair accessory for securing hair and as a therapeutic device for delivering phototherapy and other treatments.

Another object of the present invention is to provide a phototherapy hairpin comprising a head having a first stimulation element configured to provide a first therapeutic effect when the device is held in the hand of a user.

Another object of the present invention is to provide a phototherapy hairpin comprising a rod having a second stimulation element configured to provide a second therapeutic effect to the scalp when the device is secured in the hair of a user.

Another object of the present invention is to provide a phototherapy hairpin with automatic mode detection using one or more sensors to detect whether the device is secured in hair or held in hand, and a control board configured to automatically activate the appropriate stimulation element based on the detected mode.

Another object of the present invention is to provide a phototherapy hairpin wherein the rod includes a distal tip having a third stimulation element configured to provide an additional therapeutic effect. Yet another object of the present invention is to provide a phototherapy hairpin wherein the distal tip of the rod includes a storage chamber for storing and dispensing therapeutic substances such as serums, medications, or hair growth formulations onto the scalp.

Still another object of the present invention is to provide a phototherapy hairpin with a light-transmitting shell configured to serve dual functions of transmitting therapeutic light for phototherapy and contacting human skin for massage.

Another object of the present invention is to provide a phototherapy hairpin wherein the head comprises a spherical roller ball rotatably mounted on the head, configured to roll on the skin while transmitting therapeutic light.

Another object of the present invention is to provide a phototherapy hairpin with selective activation of the light strip on the rod, wherein only the light strip covered by hair is activated to maintain aesthetic appearance.

Another object of the present invention is to provide a phototherapy hairpin with a detachable connection between the rod and the head to facilitate modular assembly, disassembly, cleaning, and component replacement.

Another object of the present invention is to provide a phototherapy hairpin with a magnetic charging interface comprising a magnetic electrode configured to magnetically couple with a charging plug, eliminating exposed electrical contacts.

Another object of the present invention is to provide a phototherapy hairpin with a removable protective cover configured to cover the head when the device is secured in hair or stored, maintaining the hygiene of the treatment surface.

### SUMMARY OF THE INVENTION

According to a first aspect of the invention, a phototherapy hairpin is provided. The phototherapy hairpin comprising: a hairpin body configured to secure and tie hair of a user, a hairpin body having a mounting cavity at one end and a light emission hole communicating with the mounting cavity; a control board disposed within the mounting cavity; a lamp board disposed within the mounting cavity and electrically connected to the control board, the lamp board configured to emit light; and a light-transmitting shell mounted on the hairpin body and covering the light emission hole, wherein light emitted by the lamp board passes through the light-transmitting shell to irradiate outwardly, and wherein the light-transmitting shell is configured to contact human skin for massage, wherein the light-transmitting shell serves a dual function of delivering controlled phototherapy and providing a massage surface, when the phototherapy hairpin is either held in a hand of a user or positioned in contact with the skin of the user.

In one embodiment of the invention, the light emission hole penetrates through the hairpin body, wherein the phototherapy hairpin comprises two light-transmitting shells respectively covering opposite ends of the light emission hole, the lamp board being positioned between the two light-transmitting shells.

In one embodiment of the invention, the light-transmitting shell comprises a jade massage block.

In one embodiment of the invention, the light-transmitting shell has a skin-contacting surface exposed outside the hairpin body, the skin-contacting surface being an outwardly convex arc surface.

In one embodiment of the invention, the hairpin body comprises a limiting strip surrounding the light emission hole, the limiting strip abutting against a side wall of the light-transmitting shell, and wherein the limiting strip has a notch exposing a portion of the side wall of the light-transmitting shell.

In one embodiment of the invention, the phototherapy hairpin further comprising: a battery disposed within the hairpin body and electrically connected to the control board; a charging port formed in the hairpin body; and a magnetic electrode having one end electrically connected to the control board and another end extending into the charging port, wherein the magnetic electrode is configured to magnetically couple with a charging plug.

In one embodiment of the invention, the hairpin body comprises a rod and a head detachably connected to the rod, the head having the mounting cavity and the light emission hole, wherein the diameter of the head is larger than the diameter of the rod.

In one embodiment of the invention, the rod and the head are detachably connected by at least one of: a locking block on one of an outer wall of the rod and an inner wall of the head engaged with a locking hole on the other; or a magnetic attachment wherein magnets are disposed in the rod and the head provide magnetic attraction for connection.

According to a second aspect of the invention, a phototherapy hairpin for dual-mode operation is provided. The phototherapy hairpin comprising: a head comprising a mounting cavity and a first stimulation element disposed within the mounting cavity, the first stimulation element being configured to provide first therapeutic effect; a rod having a first end coupled to the head and a distal tip configured to engage hair of a user when the phototherapy hairpin is won, and to be gripped by the user when the phototherapy hairpin is held in the hand, the rod comprising a second stimulation element configured to provide a second therapeutic effect; wherein the rod is configured to attached with the head; one or more sensors configured to detect whether the phototherapy hairpin is secured in the hair of the user or held in hand of the user; and a control board electrically connected to the first stimulation element, the second stimulation element and the one or more sensors, the control board configured to automatically activate the first stimulation element when the one or more sensors detect that the phototherapy hairpin is held in the hand of the user, and to activate the second stimulation element when the one or more sensors detect that the phototherapy hairpin is secured in the hair of the user.

In one embodiment of the invention, the head further comprises a light-transmitting shell having a single spherical roller ball rotatably mounted on one side of the head, the roller ball configured to roll on the skin while transmitting therapeutic light.

In one embodiment of the invention, the head includes a removable protective cover configured to cover the light-transmitting shell when the phototherapy hairpin is secured in the hair or stored.

In one embodiment of the invention, the head comprises two spherical roller balls rotatably mounted on opposite sides of the head, each roller ball configured to roll on the skin while transmitting therapeutic light.

In one embodiment of the invention, the distal tip of the rod comprises a second stimulation element configured to provide therapy to the scalp when the phototherapy hairpin is secured in the hair, the second stimulation element comprising at least one of: a microcurrent electrode, a vibration motor, a thermal element, or an ultrasonic transducer.

In one embodiment of the invention, the distal tip of the rod comprises a storage chamber configured to store and dispense a substance onto the scalp of the user, the substance comprising at least one of: a serum, a medication, a hair growth formulation, or a cosmetic formulation.

In one embodiment of the invention, the one or more sensors comprise at least one of: a capacitive sensor, a pressure sensor, an accelerometer, a gyroscope, an optical proximity sensor, or an ambient light sensor.

In one embodiment of the invention, the rod comprises a plurality of independently addressable light strips, and the control board is configured to selectively activate only those light strips that are covered by hair based on input from the one or more sensors.

According to a third aspect of the invention, a method of providing phototherapy using a phototherapy hairpin comprising a head having a first stimulation element, and a rod having a second stimulation element is provided. The method comprising: detecting, by one or more sensors, whether the phototherapy hairpin is secured in hair of a user or held in a hand of the user; when the one or more sensors detect that the phototherapy hairpin is secured in the hair of the user: activating, by a control board, the second stimulation element disposed on the rod to provide a second therapeutic effect to a scalp of the user; and when the one or more sensors detect that the phototherapy hairpin is held in the hand of the user: activating, by the control board, the first stimulation element to provide a first therapeutic effect.

In one embodiment of the invention, detecting whether the phototherapy hairpin is secured in the hair or held in the hand comprises sensing at least one of: a capacitance change indicative of scalp proximity, a pressure indicative of grip or hair contact, an orientation of the phototherapy hairpin, or an ambient light level.

In one embodiment of the invention, the method further comprises dispensing a substance from a storage chamber disposed at the distal tip of the rod onto the scalp of the user while providing scalp phototherapy.

In one embodiment of the invention, the method further comprising providing a second stimulation therapy to the scalp via a stimulation element disposed at a distal tip of the rod, the second stimulation therapy comprising at least one of: as phototherapy, microcurrent therapy, heating therapy, cooling therapy, vibrational therapy, ultrasonic wave therapy, magnetotherapy, electrical stimulation, Tens, RF, pulsed electromagnetic field (PEMF) etc. In the context of the specification, when an element is referred to as being “fixed to” or “disposed to” another element, it may either be directly on another element or indirectly on that other element. When a component is said to be “connected” or “connected to” another component, it may be directly connected to another component or indirectly connected to other components on the piece.

In the context of the specification, the terms “first”, “second,” and “third” are only used for descriptive purposes and do not imply the relative importance or implicitly indicate the quantity of technical features indicated.

In the context of the specification, the term “plurality” means two or more than two, unless otherwise indicated.

In the context of the specification, the term "several" means more than one, unless otherwise specified.

In the context of the specification, the term “phototherapy hairpin” refers to any device configured to emit therapeutic light for skin treatment, pain relief, or wellness applications.

In the context of the specification, the term “stimulation element” refers broadly to any component, module, or structure configured to apply a therapeutic or cosmetic stimulus to a user’s skin or tissue. Stimulation elements may include, but are not limited to, a phototherapy element, a microcurrent element, a Peltier element, a vibrational element, a thermal element, an ultrasonic wave therapy element, a magnetotherapy element, an electrical stimulation element for providing galvanic therapy, Tens therapy, RF therapy, a pulsed electromagnetic field (PEMF) element, or a combination thereof. In the context of the specification, the term “stimulation element” refers broadly to any component, module, or structure configured to apply a therapeutic or cosmetic stimulus to a user’s skin or tissue. The term “first stimulation element”, “second stimulation element”, and “third stimulation element” are for descriptive purpose and each term includes, but are not limited to, a phototherapy element, a microcurrent element, a Peltier element, a vibrational element, a thermal element, an ultrasonic wave therapy element, a magnetotherapy element, electrical stimulation elements, galvanic element, Tens element, RF element, a pulsed electromagnetic field (PEMF) element or a combination thereof. In the context of the specification, the term “first therapeutic effect” denotes the effect generated by the first stimulation element on the skin, which includes but is not limited to skin rejuvenation, skin pore treatment, ageing, acne treatment, pigmentation, psoriasis, massaging, toning, and relief.

In the context of the specification, the term “second therapeutic effect” denotes the effect generated by the second stimulation element on the scalp and hair, which includes but is not limited to stimulating hair follicles, reducing hair fall, promoting hair growth, increasing blood circulation, reducing inflammation, neuro-treatment, stress relieving, antibacterial treatment, and pain relief.

In the context of the specification, the term “third therapeutic effect” denotes the effect generated by third stimulation element on the scalp, hair and skin, that may include but are not limited to microcurrent stimulation to stimulate hair follicles in combinationor, skin to promote cellular activity; vibration to improve blood circulation and provide massage; thermal therapy to enhance blood flow and relax muscles; or ultrasonic stimulation to enhance product absorption and provide deep tissue treatment.

In the context of the specification, the term “phototherapy element” encompasses any light-emitting device capable of emitting light of therapeutic wavelength(s), including but not limited to light-emitting diodes (LEDs), organic LEDs (OLEDs), laser diodes, or equivalent optical sources. The light may include ultraviolet, visible, near-infrared, or far-infrared spectra.

In the context of the specification, the term “massage element” refers to any component adapted to apply mechanical stimulation to the skin, including rotating rollers, kneading members, vibrating members, or reciprocating structures. The massage element may be fixed, detachable, or mounted for rotation or vibration relative to the housing.

In the context of the specification, the term “microcurrent element” refers to any electrode or conductive structure configured to deliver a controlled electrical signal to the user’s skin. Such elements may include paired electrodes, conductive surfaces, or pads connected to a circuit board for generating microcurrent, EMS, galvanic current, or equivalent electrical therapy.

In the context of the specification, the term “housing” is intended to cover any casing, enclosure, or structural body that contains or supports components of the device. The housing may include a handle portion, head, or other segments, and may be made from polymeric, metallic, composite, or other suitable materials.

In the context of the specification, the terms “head” or “phototherapy head” refer to a portion of the device coupled to the housing and configured to emit light toward the skin. The head may include one or more light-transmitting surfaces, optical lenses, or diffusers, and may also support electrodes or other stimulation elements.

In the context of the specification, the term “control interface” refers to any input or output mechanism enabling a user to operate the device. The control interface may include physical buttons, capacitive touch sensors, sliders, switches, or graphical displays, and may further include wireless control via a mobile application.

In the context of the specification, the term “control or circuit board” encompasses any printed circuit board (PCB), flexible circuit, or equivalent substrate that supports and electrically connects components of the device, including power supplies, control chips, drivers, or stimulation elements.

In the context of the specification, the term “user” or “subject” is intended to broadly cover humans, animals, or other recipients of the treatment, unless otherwise specifically limited.

In the context of the specification, the term "LED module" refers to one or more light-emitting diode (LED) elements that are electrically connected and configured to emit light of specific wavelengths suitable for therapeutic purposes. The LED module may include drive circuitry, heat dissipation structures, and optical elements such as lenses or diffusers to control light distribution.

In the context of the specification, the term “light source” or “phototherapy source” etc. refers to a source emitting coherent laser light, or light-emitting diodes (“LEDs”). The term “light therapy” refers to light generated from any of the sources, such as lasers, LED sources, or Super luminous diodes (“SLD”).

In the context of the specification, “Light Emitting Diodes (LEDs)” refer to semiconductor diodes capable of emitting electromagnetic radiation when supplied with an electric current. The LEDs are characterized by superior power efficiencies, smaller sizes, rapid switching speeds, physical robustness, and longer lifespans compared to incandescent or fluorescent lamps. The one or more LEDs may include through-hole type LEDs (generally emitting electromagnetic radiation in red, green, yellow, blue, and white colors), Surface Mount Technology (SMT) LEDs, Bi-color LEDs, Pulse Width Modulated RGB (Red-Green-Blue) LEDs, and high-power LEDs, among others.

Materials used in one or more LEDs may vary from one embodiment to another, depending upon the frequency of radiation required. Different frequencies can be obtained from LEDs made from pure or doped semiconductor materials. Commonly used semiconductor materials include nitrides of Silicon, Gallium, Aluminum, Boron, Zinc Selenide, etc., in pure form or doped with elements such as Aluminum and Indium. For example, red and amber colors are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used to generate a wider color gamut. White and other colored lightings may also be produced using phosphor coatings such as Yttrium Aluminum Garnet (YAG) in combination with a blue LED to generate white light, and Magnesium-doped potassium fluorosilicate in combination with a blue LED to generate red light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, a discussion on the generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety by reference.

In the context of this specification, terms like “light”, “radiation”, “irradiation”, “emission” and “illumination”, etc. refer to electromagnetic radiation in frequency ranges varying from the Ultraviolet (UV) frequencies to Infrared (IR) frequencies and wavelengths, wherein the range is inclusive of visible light, UV and IR frequencies and wavelengths. It is to be noted here that UV radiation can be categorized in several ways depending on respective wavelength ranges, all of which are envisaged to be under the scope of this invention. For example, UV radiation can be categorized as Hydrogen Lyman-α (122-121 nm), Far UV (200-122 nm), Middle UV (300-200 nm), and Near UV (400-300 nm). The UV radiation may also be categorized as UVA (400-315 nm), UVB (315-280 nm), and UVC (280-100 nm). Similarly, IR radiation may also be categorized into several categories according to respective wavelength ranges, which are again envisaged to be within the scope of this invention. A commonly used subdivision scheme for IR radiation includes Near IR (0.75-1.4 μm), Short-Wavelength IR (1.4-3 μm), Mid-Wavelength IR (3-8 μm), Long-Wavelength IR (8-15 μm), and Far IR (15-1000 μm).

Unless otherwise stated, the term “light” as used in this specification encompasses electromagnetic radiation in the visible (380–780 nm) and infrared (780 nm–1000 nm) ranges, particularly red light (620–750 nm) and near-infrared (750–1400 nm) wavelengths commonly used in photobiomodulation therapy. Particular wavelengths which may be selected as the dominant emissive wavelength may include the follow, without any preference to be indicated by order: 400 nm, 405 nm, 420 nm, 430 nm, 450 nm, 465 nm, 515 nm, 530 nm, 532 nm, 590 nm, 630 nm, 633 nm, 640 nm, 650 nm, 655 nm, 660 nm, 670 nm, 680 nm, 780 nm, 785 nm, 810 nm, 830 nm, 840 nm, 850 nm, 860 nm, 870 nm, 904 nm, 915 nm, 980 nm, 1015 nm, 1060 nm, 1065 nm, 1070 nm, 1200, and 1400 nm. As used herein, the term “light therapy” refers to the use of one or more light sources of any type that emit light with a wavelength between about 400 and 1400 nm. The device may also emit blue or ultraviolet light for surface-level treatments such as acne reduction or microbial control.

The red light (approximately 630–660 nm) penetrates deeply into the scalp to stimulate blood circulation and enhance hair follicle activity, thus promoting hair growth and repair. Blue light (around 415–470 nm) exhibits antibacterial properties and is effective in treating scalp acne and reducing inflammation. Green light (approximately 520–540 nm) can help reduce pigmentation and soothe sensitive or irritated scalp tissue. Yellow light (around 580–600 nm) improves oxygen exchange in the cells and aids in detoxifying the scalp, while near-infrared light (800–850 nm) reaches deeper layers to accelerate healing and reduce pain and inflammation. Green light (approximately 520–540 nm) can help reduce pigmentation and soothe sensitive or irritated scalp tissue. Yellow light (around 580–600 nm) improves oxygen exchange in the cells and aids in detoxifying the scalp, while near-infrared light (800–850 nm) reaches deeper layers to accelerate healing and reduce pain.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings, wherein like reference letters and numerals indicate the corresponding parts in various figures in the accompanying drawings, and in which:

FIG. 1 shows a perspective view of a phototherapy hairpin, in accordance with an embodiment of the present invention.

FIG. 2 shows the perspective view of a head of the phototherapy hairpin, in accordance with an embodiment of the present invention.

FIG. 3 shows an exploded view of the head of the phototherapy hairpin, in accordance with an embodiment of the present invention.

FIG. 4 shows an exploded view of a light-transmitting shell of the head of the phototherapy hairpin, in accordance with an embodiment of the present invention.

FIG. 5 shows a magnetic electrode structure used in the head of the phototherapy hairpin for charging, in accordance with an embodiment of the present invention.

FIG. 6 illustrates the phototherapy hairpin connecting to a charging plug, in accordance with an embodiment of the present invention.

FIG. 7 shows an exploded view of the phototherapy hairpin, in accordance with an embodiment of the present invention.

FIG. 8 shows an exploded view of a translucent rod and a rolling phototherapy shell of the phototherapy hairpin, in accordance with an embodiment of the present invention.

FIG. 9 shows a perspective view of the phototherapy hairpin showing the configuration of the head, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

In an embodiment, a phototherapy hairpin is provided. The phototherapy hairpin comprises an elongated hairpin body, a control board, a lamp board, and a light-transmitting shell. The head of the phototherapy hairpin defines a mounting cavity and a light emission hole leading to that cavity. The control board and the lamp board are mounted together inside the mounting cavity and electrically connected. The lamp board carries a plurality of LEDs on its substrate. When the device is turned on via the control switch, present on the exterior of the body, the control board powers the LEDs. Light generated by the LEDs propagates through the interior of the phototherapy hairpin and exits outward through the light-emission hole and the light-transmitting shell. Therapeutic light is delivered at least through the light-transmitting shell. The thickness and optical properties of the light-transmitting shell set a fixed distance between the lamp board and the skin, ensuring consistent spacing and thus reproducible light dosage with each use. Light transmitting shell also serves as the user’s point of contact and massage surface.

In some embodiments, the light-transmitting shell is mounted to cover the light-emission hole in the head. The mounting surface is fitted closely against the hairpin body to minimize any air gap or light leakage. The mounting surface may be substantially flat and precisely shaped to mate with the opening in the head. Eliminating gaps at this interface improves safety and provides a strong mechanical joint. The outer skin contacting surface of the light-transmitting shell is typically formed as a convex, rounded shape that protrudes slightly beyond the head’s contour. This curved projection increases the contact area with the skin. The convex shape helps the light-transmitting shell conform to facial contours or joints. As the light-transmitting shell rolls or glides, it provides a smooth massaging action. By pressing snugly against the epidermis, the convex light-transmitting shell both concentrates the emitted light on the treatment area and reduces scattering losses. Good optical coupling of light into the skin is achieved when the translucent shell directly contacts the tissue.

In some embodiments, the light-emission hole is formed all the way through the thickness of the head, minimizing optical path length and internal scattering. A shallow hole depth reduces machining time and preserves the head’s strength. In one arrangement, two light-transmitting shells are provided on opposite sides of the head; the head has a through light emission hole with a transparent shell on the front face and another on the rear face. Lamp boards on each face of the head then emit light through their respective shells. The user can choose which side of the head to press against the skin, allowing two simultaneous or alternative treatment faces. This dual-sided configuration broadens the coverage of phototherapy. The phototherapy hairpin remains compact and easy to manipulate, yet the dual bulbs and shells yield a more uniform, enveloping light distribution than a single-sided emitter.

The lamp board typically comprises a rigid substrate carrying a plurality of LED elements at spaced intervals. In some embodiments, LEDs are placed on both the front and back faces of the board to reduce blind spots. The LEDs may emit different wavelengths: for instance, a mix of red and blue light. As shown by clinical studies, red light stimulates fibroblasts and collagen production, aiding tissue repair, while blue light inhibits sebum glands and kills P. acnes bacteria. Combined red and blue treatment has synergistic benefits for skin rejuvenation and acne treatment.

In one embodiment, the control board drives the LEDs so that roughly equal energy is delivered at both wavelengths. Optional wavelengths could be added in an alternative version, although the present device focuses on visible-red and blue for superficial dermatological effects. The illumination intensity of each LED group is kept moderate to ensure therapeutic effect while avoiding excess heating or irritation.

In one embodiment, the hairpin body can be a single-piece molding or a two-part assembly, as a rod plus a head. The rod-shaped shaft is detachable from the larger-diameter head via a locking mechanism. This allows quick assembly and disassembly by hand. The larger head houses the lamp board and control board, while the rod contains the battery. The shaft may be sleeved into the head and locked in place. Overall, this reduces weight and size while giving ample interior space in the head for the electronics and optics.

In one embodiment, a battery is housed inside the phototherapy hairpin for portable, cordless operation. Typically, a rechargeable lithium battery is mounted in a receiving cavity at the end of the rod opposite the light head. The battery is wired to the control board to power the LEDs. Power is replenished via a magnetic charging module, a charging port leads to a magnetic electrode, one end attached to the control board, the other end flush with the charging port. When a magnetically coupled charging plug is brought near, magnetic attraction seats the plug to the phototherapy hairpin and aligns the terminals. No manual insertion of contacts is needed, simplifying the charging action. The magnetic electrode often includes a limiting step that snaps against the inner wall to lock it firmly in place during use. The charging electronics on the control board manage safe charging of the battery. For example, charging is complete when the indicator light changes state.

In one embodiment, a power status indicator light is provided on the rod near the switch. It is controlled by the control board to show battery status. For instance, when the remaining charge is equal to or more than 20 percent, the LED stays on; below 20 percent, it flashes at about 1 Hz to warn the user to recharge. Thus, simple illumination or blinking suffices for user feedback, without complex multi-colour displays. This indicator is often green or white.

The control switch is the user’s interface. In a basic configuration, the device has just two states: on or working and off or powered off. To turn on or off, the user presses and holds the switch for a preset duration to avoid accidental toggling. Once on, the control board activates the chosen LEDs. After a set treatment time, the control board automatically turns the device off to prevent overexposure. This auto timer feature ensures consistent treatment times and conserves battery. All these functions are handled by the single control board, which may include a microcontroller.

In an embodiment, the light-transmitting shell itself may be made from various materials chosen for optical clarity, toughness, and tactile feel. Jade is naturally cool to the touch and provides a pleasantly smooth massage surface. Because it is translucent, light from the LEDs passes through it. In practice, jade’s hardness and thermal mass help it feel soothing on the skin. Clinical experience suggests that cold jade can mitigate skin redness and swelling. One can hold jade stones in the freezer before use to further enhance the cooling effect. The convex shape of the jade block ensures that when pressed against the skin, it distributes pressure while conducting away heat from the skin. In addition, jade is believed to stimulate local blood flow and metabolism.

In another embodiment of the present invention, a phototherapy hairpin is provided that functions both as a hair accessory for securing hair and as a therapeutic device for delivering phototherapy and other treatments. The phototherapy hairpin comprises a hairpin body having a head and a rod. The head includes a first stimulation element configured to provide a first therapeutic effect, such as phototherapy and massage to the face or body, when the device is held in the hand of a user. The rod includes a second stimulation element configured to provide a second therapeutic effect, such as phototherapy to the scalp to stimulate hair follicles and promote hair growth, when the device is secured in the hair of a user. The rod is configured to be attached to the head and may be detachably connected to facilitate modular assembly, disassembly, cleaning, and component replacement.

The phototherapy hairpin includes one or more sensors configured to detect whether the device is secured in the hair of the user or held in the hand of the user. A control board is electrically connected to the first stimulation element, the second stimulation element, and the one or more sensors. The control board is configured to automatically activate the first stimulation element when the sensors detect that the phototherapy hairpin is held in the hand of the user, and to automatically activate the second stimulation element when the sensors detect that the phototherapy hairpin is secured in the hair of the user. This automatic mode detection and activation eliminates the need for manual mode selection, enhancing user convenience and ensuring appropriate therapy delivery based on the usage context.

In some embodiments, a distal tip of the rod includes a third stimulation element configured to provide an additional therapeutic effect, such as microcurrent therapy, heating therapy, cooling therapy, vibrational therapy, ultrasonic wave therapy, magnetotherapy, electrical stimulation, Tens, RF therapy, or pulsed electromagnetic field (PEMF). The distal tip may alternatively or additionally include a storage chamber for storing and dispensing therapeutic substances such as serums, medications, or hair growth formulations onto the scalp. The phototherapy hairpin may further include a light-transmitting shell configured to serve dual functions of transmitting therapeutic light for phototherapy and contacting human skin for massage, a magnetic charging interface for simplified recharging, a removable protective cover for maintaining hygiene, and selective activation of light strips on the rod to maintain aesthetic appearance when worn in hair.

In an embodiment, the stimulation element may comprise one or more of: a lamp board or light-emitting unit configured to emit therapeutic light for phototherapy; a microcurrent electrode configured to deliver low-level electrical current; a vibration motor configured to provide vibratory massage; a thermal element such as a resistive heater or Peltier device configured to provide heating or cooling; an ultrasonic transducer configured to emit ultrasonic waves; or any combination thereof.

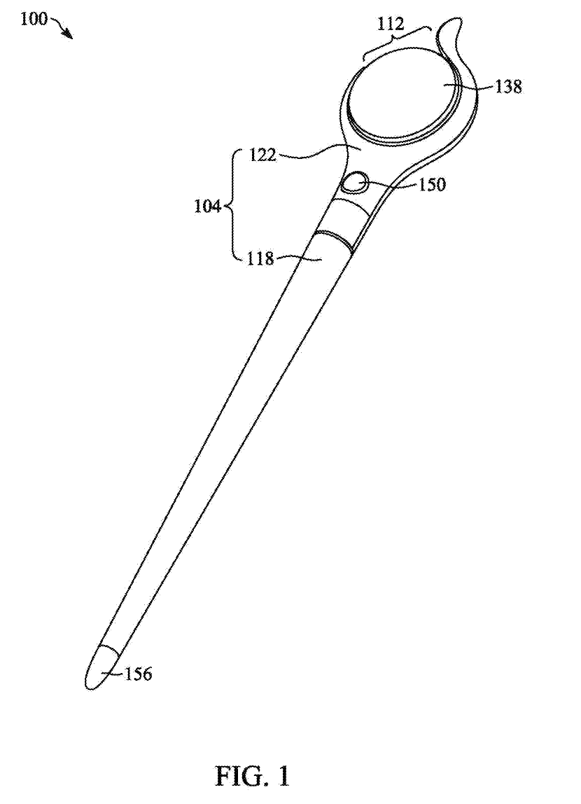

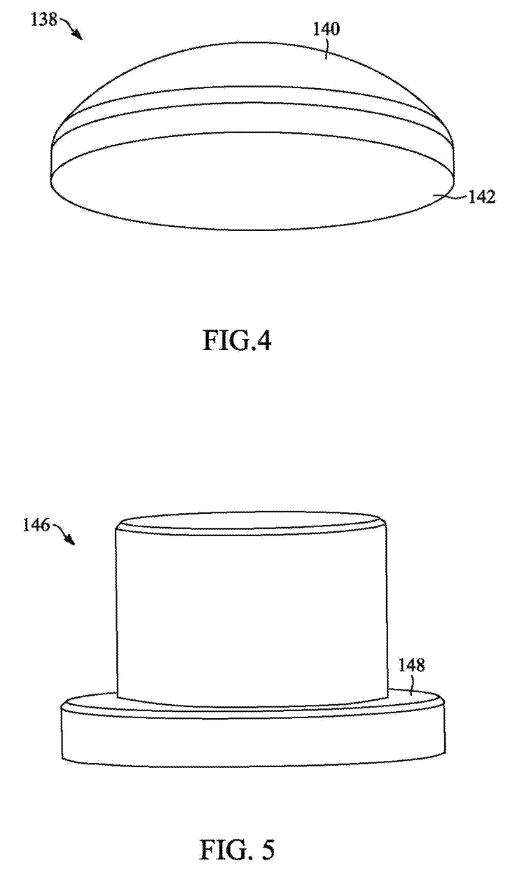

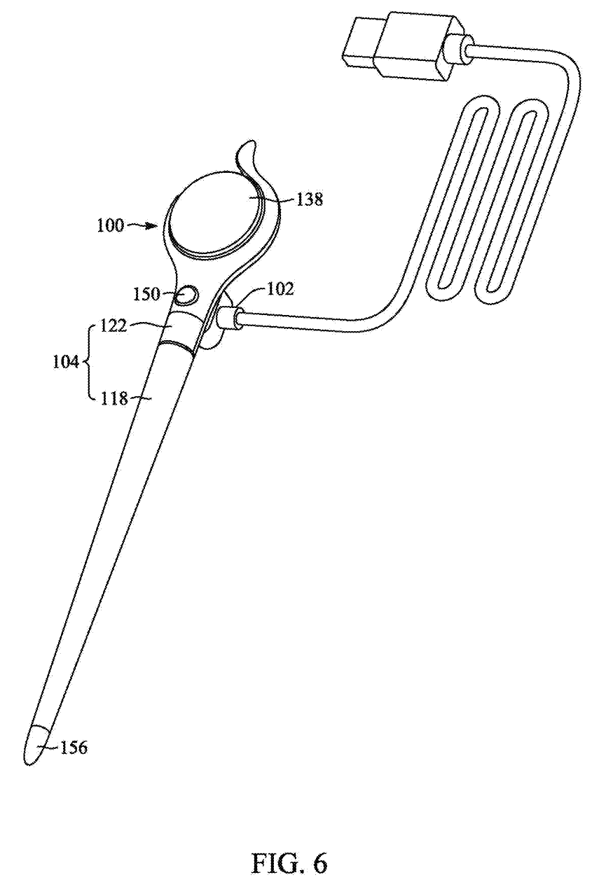

Embodiments of the present invention will now be described with reference to FIGS. 1 to 9.

In an embodiment, a phototherapy hairpin 100 is provided as a handheld device that combines a head 122 and a rod 118. The head 122 comprises a rotatable, light-transmitting spherical structure configured to contact a user’s skin during use. A control board 134 is disposed within the device body and is configured to carry all control logic for operation of the phototherapy hairpin 100.

In an embodiment, the head 122 comprises a first stimulation element. The first stimulation element may be selected from a group of stimulation elements including, but not limited to, a phototherapy element, a microcurrent element, a Peltier element, a vibrational element, a thermal element, an ultrasonic wave therapy element, a magnetotherapy element, electrical stimulation elements, galvanic element, Tens element, RF element, a pulsed electromagnetic field (PEMF) element or a combination thereof.

Referring to FIGS. 1, 2, 3, 6, and 7, the first stimulation element of the head 122 is implemented as a phototherapy element and comprises a lamp board 136 carrying a plurality of light-emitting diodes (LEDs), which are arranged within the head 122 to emit therapeutic light toward a skin-contacting surface during use. A light-transmitting shell 138 is arranged to cover the head 122, the light-transmitting shell 138 being formed of a skin-friendly translucent material and defining a convex outer skin-contacting surface 140. The lamp board 136 is disposed beneath the light-transmitting shell 138 such that light emitted by the LEDs is transmitted outward through the light-transmitting shell 138 toward the skin.

In an embodiment, the rod 118 comprises a second stimulation element 152 disposed along at least a portion of the length of the rod 118 and configured to provide a second therapeutic effect to the scalp of a user when the device is secured in the hair. The second stimulation element 152 may be selected from a group of stimulation elements including, but not limited to, a phototherapy element, a microcurrent element, a Peltier element, a vibrational element, a thermal element, an ultrasonic wave therapy element, a magnetotherapy element, electrical stimulation elements, galvanic element, Tens element, RF element, a pulsed electromagnetic field (PEMF) element, or a combination thereof.

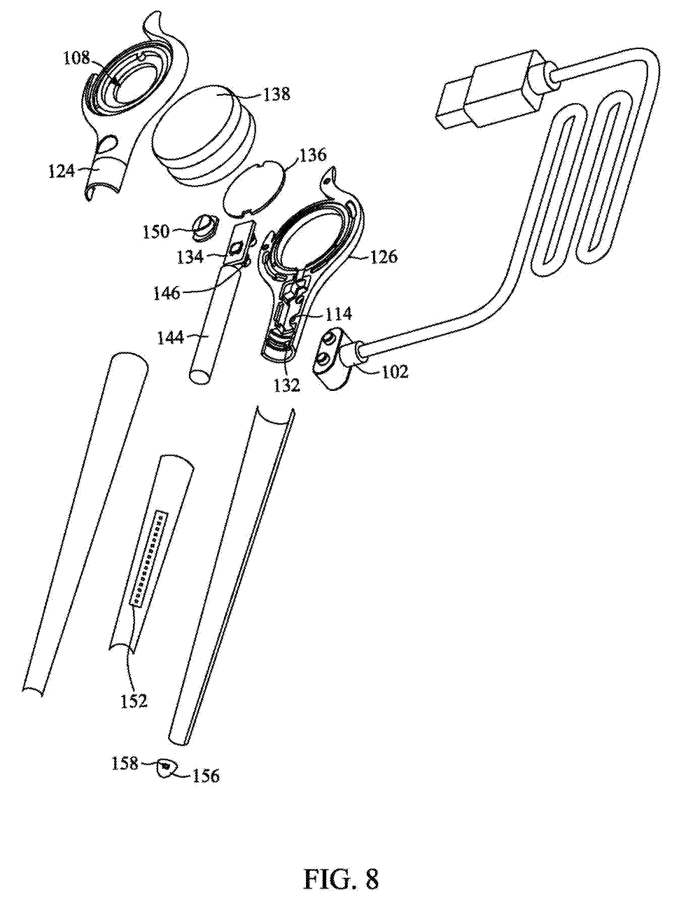

Referring to FIG. 8, the second stimulation element 152 is implemented as a phototherapy element and comprises a light strip extending along the rod 118 and containing a plurality of light-emitting diodes (LEDs) configured to emit therapeutic light toward the scalp during use.

In an embodiment, a distal tip of the rod 118 further comprises a third stimulation element disposed spaced from the second stimulation element 152. The second stimulation element 152 and the third stimulation element 158 may be the same type of stimulation element providing stimulation concurrently or different types of stimulation elements, and may independently comprise phototherapy elements, massage elements, microcurrent electrodes, ultrasonic transducers, heating elements, cooling elements, or combinations thereof. The control board is configured to selectively activate either alone or a combination of the first stimulation element, the second stimulation element 152, and the third stimulation element 158 based on an operating mode, sensed positioning of the apparatus, or a user input.

In an embodiment, the phototherapy hairpin comprises the lamp board 136 disposed within the head portion of the hairpin. The lamp board 136 is configured to deliver therapeutic stimulation to a user when the phototherapy hairpin is operated in a handheld mode. In certain embodiments, the first stimulation element may comprise one or more LEDs mounted on the lamp board 136, or may be replaced by or combined with any other stimulation element, including phototherapy elements, massage elements, microcurrent electrodes, ultrasonic transducers, heating elements, cooling elements, or combinations thereof. The lamp board 136 may be electrically connected to the control board, which regulates activation, intensity, duration, and sequencing of the first stimulation element according to a selected treatment mode or detected usage condition.

In an embodiment, a charging port 114 is provided on the device and includes a magnetic electrode 146 for establishing an electrical connection with an external power source. An internal battery 144 is electrically coupled to the charging port 114 and the control board 134 to supply operating power.

During use, actuation of the control switch 150 powers the device, whereupon the control board 134 is configured to coordinate operation of the lamp board 136, the LED elements within the rod 118, one or more indicator lights, and optional stimulation elements. Accordingly, the phototherapy hairpin 100 is capable of delivering combined phototherapy and stimulation through dual light-emitting regions formed by the head 122 and the rod 118, while overall function control, timing, power management, and multi-mode operation are centrally managed by the single control board 134. Referring to FIGS. 1 to 3, the phototherapy hairpin 100 comprises a hairpin body 104, the control board 134, the lamp board 136, and the light-transmitting shell 138. One end of the hairpin body 104 defines a mounting cavity 106 and a light emission hole 108 communicating with the mounting cavity 106. The arrangement and geometry of the hairpin body 104 render the phototherapy hairpin 100 compact, handheld, and convenient to manipulate during treatment.

In an embodiment, the light-transmitting shell 138 is mounted to the hairpin body 104 to cover the light emission hole 108. Both the control board 134 and the lamp board 136 are installed within the mounting cavity 106 and are electrically connected so that light generated by the lamp board 136 is emitted outwardly through the light-transmitting shell 138. The light-transmitting shell 138 not only provides an optical path for the light from the lamp board 136 to reach the skin but also provides a user-contacting surface that can serve a massaging function, thereby enhancing the therapeutic effect and broadening the functional capabilities of the phototherapy hairpin 100.

In some embodiments, by separating the lamp board 136 from the skin using the light-transmitting shell 138, the emitted light from the lamp board 136 is delivered to the skin in a controlled and reproducible manner. The thickness and material properties of the light-transmitting shell 138 determine the separation distance between the lamp board 136 and the skin, thereby stabilizing the source-to-target spacing and improving the reproducibility of phototherapy as compared with conventional devices. The phototherapy hairpin 100 retains an aesthetically pleasing, hairpin-style form factor that facilitates portability and ease of handling.

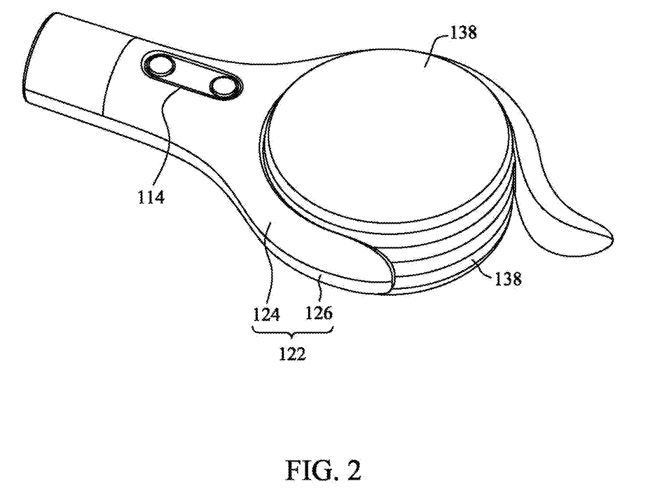

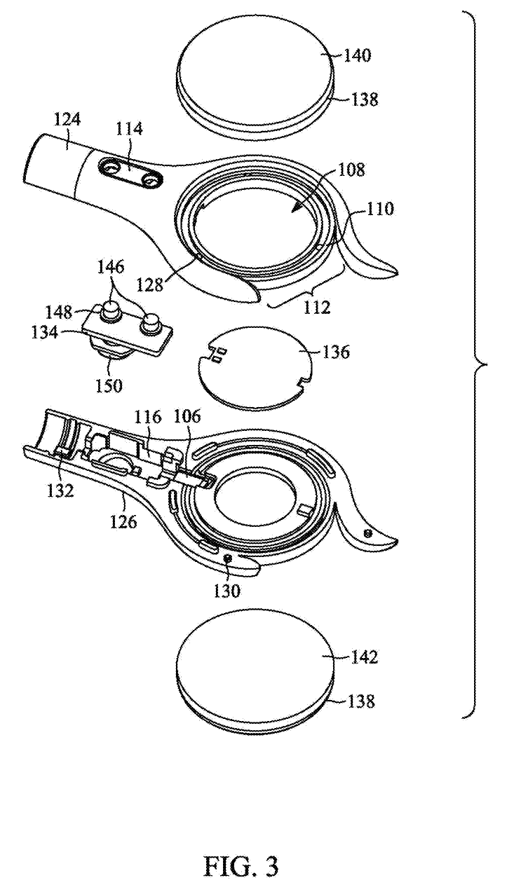

Referring to FIGS. 2 and 3, the light emission hole 108 extends through the hairpin body 104, and the light-transmitting shell 138 covers the light emission hole 108. In an embodiment, the phototherapy device comprises two light-transmitting shells 138 (a first light-transmitting shell and a second light-transmitting shell) to cover a first end and a second end of the light emission hole 108. A first lamp board is positioned between the first end of the light emission hole 108 and the first light-transmitting shell, and a second lamp board is positioned between the second end of the light emission hole 108 and the second light-transmitting shell. Light emitted by the first lamp board and the second lamp board passes through the first light-transmitting shell and the second light-transmitting shell and irradiates outward from both sides, allowing a user to select either side for treatment according to clinical need or personal comfort.

In some embodiments, the phototherapy hairpin 100 may be used at curved facial regions such as a cheek or chin, or on joints, to perform simultaneous massaging and light therapy on adjacent skin surfaces. The light emission hole 108 extends in the thickness direction of the hairpin body 104 to shorten the optical path, reduce internal reflection and scattering within the hairpin body 104, and thereby improve light transmission efficiency while minimizing machining depth and preserving the mechanical strength of the hairpin body 104. This reduces the reflection and scattering of light within the hairpin body 104, thereby improving the efficiency of light propagation and utilization. The hole depth is kept small, thereby reducing machining complexity and preserving the mechanical strength of the hairpin body 104. The reduced penetration depth decreases manufacturing effort while minimally affecting the structural stiffness of the hairpin body 104.

In an embodiment, the light-transmitting shell 138 is a natural stone, or it may be constituted in whole or in part by metallic, ceramic, or polymeric bodies. Non-limiting examples include a perforated silver block, a hollowed copper block, a hollowed alumina block, translucent silicone, glass lenses, or hollowed ceramic blocks. Selection among these materials can be made based on desired translucency, thermal conductivity, hardness, manufacturability, and cost.

In an embodiment, the skin-contacting surface 140 of the light-transmitting shell 138 is exposed beyond the outer contour of the hairpin body 104. The skin-contacting surface 140 provides improved coupling of the emitted light to the epidermis and enhances the tactile massage sensation. Acting as an optical medium, the light-transmitting shell 138 concentrates illumination on the skin; increased physical contact between the light-transmitting shell 138 and the skin reduces optical scattering and light loss, thereby improving phototherapy efficiency.

In some embodiments, the skin-contacting surface 140 is formed as an outwardly convex curved surface that projects away from the lamp board 136. A projection increases the contact area with the skin. The convex curvature improves the massaging feel during use and allows the light-transmitting shell 138 to conform more closely to anatomical curvatures found on different body regions, even joints. This conformability helps maximize the therapeutic efficacy of both light irradiation and mechanical massage.

In an embodiment, the light-transmitting shell 138 includes a mounting surface 142 adjacent the lamp board 136. The mounting surface 142 is configured for close, gap-minimizing attachment to the hairpin body 104 so that any interface gap between the light-transmitting shell 138 and the hairpin body 104 is substantially eliminated. Reducing or eliminating this gap limits light leakage at the connection and enhances user safety. Increasing the surface area of the mounting surface 142 also improves mechanical retention and installation strength. The protrusion, having a length of approximately 25 mm, increases the effective contact area with the skin, while the curved surface forms a 400 mm light-transmitting shell configured to guide and distribute emitted light toward the skin.

In an embodiment, the mounting surface 142 is substantially planar to facilitate a close fit between the light-transmitting shell 138 and the hairpin body 104. A planar mounting surface provides a larger contact region between components and therefore improves assembly stability and structural rigidity at the interface.

In an embodiment, the lamp board 136 comprises a substrate carrying a plurality of LED elements or LED beads disposed thereon and electrically connected to the control board 134. The control board 134 governs the operation of the LED elements to emit therapeutic light through the light-transmitting shell 138. Multiple LED elements may be provided and mounted at spaced intervals on the substrate to enhance the uniformity and coverage of phototherapeutic irradiation.

In some embodiments, LED elements can be arranged on both faces of the substrate to reduce blind spots and provide a more uniform illumination profile. Parameters of the LED elements on different sides of the substrate may be independently selected to address distinct treatment needs or application scenarios. Exemplary LED parameters include the number of LEDs, their spatial arrangement, rated power, and optical output.

In some embodiments, the emitted light from the lamp board 136 includes at least one of red and blue spectral components. The combined application of red and blue light enables synergistic phototherapeutic effects; red light promotes cellular metabolism and tissue repair, while blue light exhibits antibacterial activity and suppresses sebum production. Optionally, the red wavelength is approximately 630 nm, and the blue wavelength is approximately 415 nm, though other effective wavelengths within known therapeutic ranges may be used.

Emitted irradiance for red and blue light may be maintained within a moderate range, for example, between 20 mW/cm² and 40 mW/cm², with selectable values including 20, 25, 30, 35, or 40 mW/cm², to ensure therapeutic efficacy while avoiding excessive tissue exposure.

In one embodiment, the combined irradiance of the red light at approximately 630 nm and blue light at approximately 415 nm spectral components at the skin-facing surface of the light-transmitting shell 138 or at the surface of the rod 118 when used, is approximately 30 mW/cm², with an allowable tolerance of ±5 mW/cm² that is, 30 ± 5 mW/cm². This combined-power setting is achieved by selecting LED drive currents, spatial arrangement of emitters on the lamp board 136, and the optical transmission characteristics and separation provided by the light-transmitting shell 138 so that the delivered dose remains within the moderate irradiance range, for example, 20–40 mW/cm². Maintaining the combined red, blue irradiance at about 30 ± 5 mW/cm² provides a reproducible, balanced phototherapeutic output suitable for the combined red- light and blue-light treatment modes described herein while preserving user comfort and safety.

In an embodiment, the light-transmitting shell 138 is a jade massage block intended for direct contact with human skin. The jade massage block permits transmission of light emitted by the lamp board 136 while simultaneously serving as a massage element. The hardness, geometry, and surface finish of the jade block are selected to provide a comfortable and effective massage action on the skin surface. Jade exhibits a naturally cool tactile feel; when presented in a massage block, the material’s topical cooling effect can assist in reducing local skin temperature and in relieving inflammation and swelling on contact with the skin.

In an embodiment, during phototherapy, the inherent cooling provided by the jade massage block augments the therapeutic outcome by helping to mitigate redness and soothe inflamed or sensitive skin. The mechanical massage applied by the jade block promotes local blood circulation and can improve skin elasticity and metabolic activity. When used together with phototherapy, these combined effects may accelerate epidermal cell regeneration and repair processes, thereby improving overall skin condition and quality.

In another embodiment, the material of the light-transmitting shell 138 is selected from a group comprising quartz, nephrite, jadeite, or a translucent marble. A translucent marble shell is a cost-effective alternative to jadeite or nephrite while offering high compressive strength and improved wear resistance, thereby extending product lifetime and broadening potential applications. The light-transmitting shell 138 may be formed from a single material or a composite of compatible materials to achieve desired optical, mechanical, and tactile properties. By selecting different materials, such as Quartz, Jade as nephrite or jadeite, Tourmaline, Quartz or rose quartz, Graphite carbon, Polymers, Glass or ceramic, Composite materials, the device can tailor the tactile and thermal effects.

Referring to FIGS. 2 and 3, the hairpin body 104 includes a limiting feature disposed about the light emission hole 108. A limiting strip 110 abuts the sidewall of the light-transmitting shell 138 to maintain the light-transmitting shell 138 in a correct radial position during installation and to prevent displacement caused by external forces or manufacturing tolerances.

The limiting strip 110 incorporates a notch 112 that permits a portion of the light-transmitting shell 138 to protrude through the notch 112. The exposed sidewall region of light-transmitting shell 138 permits phototherapeutic irradiation and direct skin contact at that location, and the notch 112 facilitates assembly and disassembly of the light-transmitting shell 138 relative to the hairpin body 104.

In an embodiment, the central angle subtended by the notch 112 at the center of the circular light emission hole 108 ranges from 20° to 100°. A central angle of at least 20° ensures that a sufficient emission sector is available for treatment coverage, while a central angle not exceeding 100° preserves the structural and retaining function of the limiting strip 110.

In an embodiment, the light-transmitting shell 138 is equipped with a temperature-regulating component electrically connected to the control board 134. The temperature-regulating component enables heating or cooling of the light-transmitting shell 138 to provide hot- or cold-compress therapy. Applying heat can promote blood circulation, provide anti-inflammatory and warming effects, relieve fatigue, and is therefore suitable for certain chronic conditions. Cooling can constrict local vasculature to reduce redness and swelling, relieve pain, and provide anti-inflammatory effects suitable for acute conditions. The temperature regulating component may take the form of a resistive heating element, a thermoelectric or Peltier module, a cold-source pad, or other suitable heating or cooling means, and is controlled by the control board 134 to provide selected temperature profiles. In some embodiments, the light-transmitting shell 138 is mounted to the hairpin body 104 by an elastic member so that the light-transmitting shell 138 possesses a degree of compliance; this elasticity enables the light-transmitting shell 138 to conform closely to skin contours and to exert a measure of contact pressure that enhances massage efficacy.

In an embodiment, the light-transmitting shell 138 is mounted to the hairpin body 104 via an elastic member. The light-transmitting shell 138 is designed to have a predetermined degree of elasticity and structural compliance, enabling the light-transmitting shell 138 to adapt to and closely conform with human skin having different shapes and curvatures. Owing to this elastic characteristic, the light-transmitting shell 138 is configured to exert a controlled contact pressure against the skin during use, thereby providing a massage or stimulation effect in addition to light transmission.

In an embodiment, the light-transmitting shell 138 is mounted to the hairpin body 104 via a ball-joint arrangement so that the light-transmitting shell 138 can rotate freely and adapt to different skin angles and curvatures. This ball joint mounting provides the user with the ability to adjust the position and orientation of the light-transmitting shell 138 during treatment to maintain consistent contact and optimal therapeutic delivery.

Referring to FIGS. 3, 5, and 6, the phototherapy hairpin 100 further comprises the battery 144 and the magnetic electrode 146. The hairpin body 104 defines a receiving cavity at an end thereof opposite the light emission hole 108, and the battery 144 is disposed within the receiving cavity. The battery 144 is electrically connected to the control board 134 to supply operating power thereto. A first end of the magnetic electrode 146 is electrically connected to the charging port 114, and a second end of the magnetic electrode 146 is connected to the control board 134.

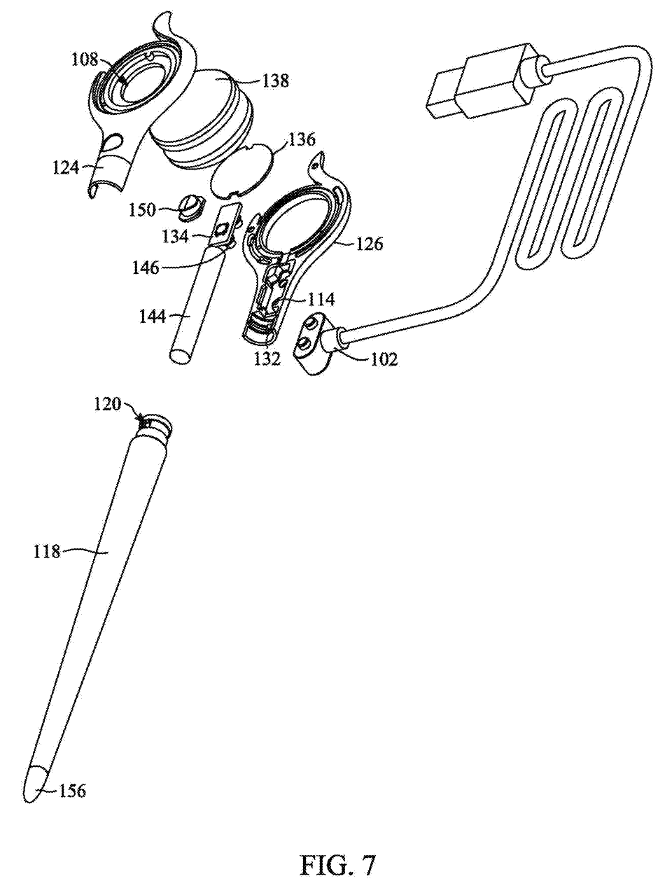

Referring to FIG. 7 and 8, the built-in battery 144 enables the phototherapy hairpin 100 to operate independently without reliance on an external power source, thereby significantly improving convenience and portability. During charging, a user only needs to bring a charging plug 102 into proximity with the charging port 114, whereupon magnetic attraction causes automatic alignment and attachment. This magnetic charging configuration eliminates the need for repeated manual plugging and unplugging, thereby simplifying operation and improving charging efficiency. Correspondingly, the charging plug 102 is provided with a magnetic charging terminal configured to mate with the magnetic electrode 146.

In some embodiments, the battery 144 has a compact size and a capacity ranging from approximately 50 mAh to 70 mAh without being restricted to it, which is suitable for lightweight and portable use. With such a capacity, the phototherapy hairpin 100 can continuously operate for more than three hours under normal working conditions.

In one embodiment, the phototherapy hairpin 100 further comprises a power indicator light mounted on the hairpin body 104 and electrically connected to the control board 134. The power indicator light is configured to indicate the power status of the battery 144. During operation, when a remaining charge level of the battery 144 is greater than or equal to 20% of the rated capacity, the power indicator light remains continuously illuminated. When the remaining charge level of the battery 144 is below 20% of the rated capacity, the power indicator light operates in a flashing state.

In an embodiment, the power indicator light operates using a single light source without requiring multiple colour indicators, thereby simplifying the overall structure and control logic of the phototherapy hairpin 100. A flashing frequency of the power indicator light may be selected, for example, at approximately 1 Hz. The emitted light colour of the power indicator light may be selected from green, purple, white, or other colours, and is not limited to any particular colour.

In an embodiment, the control board 134 comprises a low-power microcontroller, for example, an ARM Cortex-M class MCU, interfaced to an LED driver capable of per-segment current control and to analog front-ends for capacitive and pressure sensing. A rechargeable lithium-ion or lithium-polymer cell, nominal 3.7 V with a capacity in the range of 50 to 200 mAh, is electrically connected to the control board 134 through the charging management IC. Charging is via a magnetically coupled contact or Qi-compatible receiver with charge current limited to a safe value, for example, 100 mA. The LED outputs are limited so that irradiance at the skin surface for any single wavelength does not exceed safe exposure levels for example the representative range, 1 to 50 mW/cm² per treatment surface and the control board 134 monitors skin or internal temperature using a thermistor, if the measured temperature exceeds a preset threshold, the board will immediately reduce or disable power to the stimulation elements and alert the user by blinking the power indicator. Electrical safety measures include series current limiting for microcurrent electrodes, isolation between high-current LED drivers and sensing circuits, and a watchdog timer to return the device to a safe off-state on a firmware fault.

Referring to FIGS. 5 to 7, the magnetic electrode 146 is arranged with a limiting step 148. The limiting step 148 abuts against an inner wall of the hairpin body 104 such that a portion of the magnetic electrode 146 extending into the charging port 114 is partially positioned within the mounting cavity 106. The cooperation between the limiting step 148 and the inner wall of the hairpin body 104 ensures that the magnetic electrode 146 is securely retained at the charging port 114, preventing loosening, shaking, or detachment during repeated use or charging.

Referring to FIGS. 3 to 7, a mounting groove 116 is formed within the mounting cavity 106. The control board 134 is installed within the mounting groove 116, and the charging port 114 is formed at the bottom portion of the mounting groove 116. This arrangement shortens the electrical path between the control board 134 and the magnetic electrode 146, thereby reducing transmission losses and improving electrical conductivity. At the same time, positioning the control board 134 within the mounting groove 116 and arranging the charging port 114 at the bottom thereof allows more efficient utilization of internal space within the mounting cavity 106, which contributes to reducing the overall size of the phototherapy hairpin 100 and improving portability.

Referring to FIGS. 1 to 3, the control switch 150 is electrically connected to the control board 134 and is exposed on the exterior of the hairpin body 104, allowing a user to control the operating state of the phototherapy hairpin 100. The single control switch 150 is provided without restricting it, thereby simplifying user operation and enhancing ease of use.

In an embodiment, the phototherapy hairpin 100 operates in two basic states, namely a working state and a powered-off state, without being restricted to these. The control switch 150 is configured to toggle between these states. When the control switch 150 is pressed and held for longer than a first preset time, the phototherapy hairpin 100 enters the working state. Pressing and holding the control switch 150 again for longer than the first preset time switches the device to the off state. This long-press activation mechanism helps prevent accidental operation during handling or transport. To prevent excessive phototherapy exposure and to further simplify operation, the lamp board 136 is configured to automatically shut off after operating for longer than a preset time. Upon reaching the second preset time, the phototherapy hairpin 100 automatically transitions to the power-off state.

In order to prevent excessive phototherapy exposure and to facilitate user operation, the lamp board 136 is configured to operate for a preset duration. Upon expiration of a second preset time period, the phototherapy hairpin 100 automatically enters a power-off state. The second preset time period may be selectively set, for example, to 1 minute, 2 minutes, 3 minutes, 5 minutes, or 10 minutes, and is not limited thereto.

In an embodiment, the hairpin body 104 is made of a material selected from a group consisting of but not limited to a metal or polymer material, including but not limited to aluminium alloy, plastic, or iron alloy, which provides a favourable combination of low density, high strength, and durability, thereby reducing weight while maintaining structural robustness.

The outer surface of the hairpin body 104 is provided with a frosted finish. The frosted surface improves tactile comfort during gripping, enhances resistance to fingerprints and scratches, and improves the overall durability and aesthetic quality of the phototherapy hairpin 100. The frosted surface may be formed by a fine sandblasting process without restriction.

In an embodiment, the stimulation element may operate independently or in combination with the others to provide a multi-modal treatment experience.

In an embodiment, the stimulation element can be the microcurrent component configured to provide microcurrent stimulation therapy. The microcurrent component may include one or more electrodes disposed on the surface of the housing, such as on the end face or connecting surface, and electrically connected to the internal circuit board. The circuit board is configured to generate controlled low-level electrical pulses that are delivered through the electrodes to the user’s skin. Such microcurrent stimulation aids in promoting circulation, improving cellular energy (ATP) production, and enhancing skin tone and elasticity. The microcurrent component may operate independently or concurrently with other stimulation elements such as the phototherapy, thermal, or ultrasonic modules to produce synergistic cosmetic and therapeutic effects.

In an embodiment, the stimulation element can be the heating and cooling component configured to provide controlled thermal therapy. The heating and cooling component may include a Peltier module, a resistive heating plate, or a thermoelectric component disposed beneath or adjacent to the light-transmitting plate. The thermal component is thermally coupled to the surface of the housing so that heat or coolness is effectively transferred to the user’s skin. The control circuit regulates the direction and magnitude of current through the Peltier component to alternately produce heating or cooling effects.

In an embodiment, the stimulation element can be the magneto-therapy component that may include one or more electromagnetic coils or permanent magnets configured to generate a pulsed or static magnetic field to promote blood circulation and cellular metabolism. The stimulation element can be the ultrasonic wave therapy component that may include one or more piezoelectric transducers adapted to emit ultrasonic vibrations in the range of 0.8-3 MHz to stimulate tissue regeneration, enhance transdermal absorption of skincare products, and relieve muscular tension.

In an embodiment, the phototherapy component provides optical stimulation using specific wavelengths of light, while the microcurrent component delivers controlled low-level electric currents through electrodes on the device surface. The heating and cooling components, including the thermoelectric (Peltier) component, regulate the surface temperature to deliver thermal therapy for soothing or tightening skin. All these components may be controlled individually or simultaneously through the circuit board and user interface, allowing the user to select desired therapy modes depending on treatment needs.

In an embodiment, the outer surface of the hairpin body 104 is further provided with an oxide layer to inhibit oxidation of the underlying metal material and to extend service life under various usage conditions. The hairpin body 104 is subjected to anodic oxidation treatment. The outer surface may first be processed by fine sandblasting to form a frosted texture, followed by anodizing or other surface treatments to further enhance durability, corrosion resistance, and visual appearance. An oxide layer is formed on the sanded surface using an anodizing process.

In some embodiments, the hairpin body 104 comprises the rod 118 and the head 122 that are detachably interconnected. The head 122 defines the mounting cavity 106 and the light emission hole 108 for emitting therapeutic light; the diameter of the light emission hole 108 is greater than the diameter of the rod 118, which could also emit therapeutic light. The control board 134 and the lamp board 136 are mounted to the head 122 and arranged within the mounting cavity 106. By providing the rod 118 having a smaller outside diameter than the head 122, the overall size and weight of the phototherapy hairpin 100 can be reduced, thereby improving portability and ease of manipulation, while the head 122 with a greater diameter affords increased installation space for the lamp board 136 and the control board 134 to expand the phototherapy area and enhance treatment performance.

In some embodiments, the phototherapy hairpin 100 includes heat dissipation structures configured to manage thermal energy generated by the lamp board 136 during operation, particularly when high-power LEDs are employed. The lamp board 136 may be mounted on a thermally conductive substrate, such as an aluminum or copper base, that efficiently conducts heat away from the LED junctions. The substrate may be thermally coupled to the head 122 or other portions of the hairpin body 104, which may be formed from thermally conductive materials such as aluminum alloy or other metals with high thermal conductivity. The head 122 may include an array of fins, ribs, or other extended surface features on its outer circumference or interior surfaces to increase the surface area available for heat dissipation to the surrounding air. In some embodiments, thermal interface materials, such as thermal paste or thermal pads, may be applied between the lamp board 136 and the substrate, and between the substrate and the head 122, to minimize thermal resistance and ensure efficient heat transfer. The heat dissipation structures allow the phototherapy hairpin 100 to operate at higher light output levels without exceeding safe temperature limits, thereby enhancing treatment efficacy while maintaining user safety and component reliability. Effective thermal management also extends the operational lifespan of the LEDs by preventing thermal degradation and ensuring consistent light output over the life of the device. In embodiments that include active cooling, such as a synthetic jet cooler or a small fan, the control board 134 may regulate the cooling system based on temperature sensor feedback, activating cooling when temperatures rise above a threshold and deactivating cooling when temperatures return to normal, thereby optimizing energy efficiency and minimizing noise.

In an embodiment, the interior volume of the rod 118 is in communication with the mounting cavity 106 of the head 122 so that the battery 144 is housed within the rod 118. The battery 144 is cylindrical without restricting it and is received within the internal bore of the rod 118, the axial dimensions of the battery 144 being selected to conform to the internal geometry of the rod 118.

In an embodiment, the head 122 is formed from a first cover plate 124 and a second cover plate 126. The first cover plate 124 carries a first mounting portion 128 that surrounds the light emission hole 108. The second cover plate 126 carries a second mounting portion 130 that removably mates with the first mounting portion 128. The detachable cooperation between the first mounting portion 128 and the second mounting portion 130 facilitates assembly and disassembly of the lamp board 136, the control board 134, and the light-transmitting shell 138 for purposes of manufacture, inspection, repair, or replacement. The first mounting portion 128 and the second mounting portion 130 may include one or more positioning posts and corresponding positioning holes and first and second fastener holes to receive threaded or snap fasteners, thereby improving locating accuracy and ensuring stable positional registration around the light emission hole 108.

In an embodiment, a cooperating retention arrangement is provided between the rod 118 and the head 122. A locking block 132 may be formed on one of the outer walls of the rod 118 and the inner wall of the head 122, while a complementary locking hole 120 is provided on the other component so that the locking block 132 is detachably received in the locking hole 120. This engagement provides a quick, tool-free connection between the rod 118 and the head 122, enabling simple and rapid assembly or disassembly by the user. The rod 118 is sleeved into the head 122 at one end and retained by an internal retaining mechanism in the head 122. In such arrangements, the locking block 132 is advantageously recessed or otherwise concealed so as not to be visible on the exterior surface of the device, thereby improving the external appearance and ensuring a smooth outer surface of the hairpin body 104.

In some embodiments, the hairpin body 104 is provided with waterproof and dustproof protection to enable safe use and cleaning. The hairpin body 104 may achieve a protection rating such as IP22 or higher, wherein the device is protected against solid objects greater than 12.5 mm and against dripping water when tilted up to 15 degrees vertically. This protection enables the phototherapy hairpin 100 to be used in environments where moisture may be present and facilitates routine cleaning and maintenance. The waterproof and dustproof protection may be achieved through sealing elements, gaskets, or protective coatings applied to the hairpin body 104. In some embodiments, the production process may adopt adhesive coating or overmolding techniques to ensure that the product maintains waterproof and practical characteristics during normal use, thereby extending the service life of the device and improving user safety.

In some embodiments, the rod 118 of the phototherapy hairpin 100 is formed with an outer layer of translucent thermoplastic polyurethane TPU or polyurethane PU. The second stimulation element 152 is provided within the translucent layer. The second stimulation element 152, in case of being a phototherapy element, gets activated on command from control switch 150, to emit a therapeutic light that passes through the translucent rod 118 and irradiates the skin. The rod 118 performs a phototherapy function analogous to the head-mounted LEDs. The control board 134 can operate the rod's LEDs with the same parameters, selectable wavelengths, and intensity as the head's LEDs, effectively extending the treatment area.

In an embodiment, the light-transmitting shell 138 is divided into two sections. One hemisphere of light-transmitting shell 138 is formed of translucent material, allowing light from lamp board 136 to pass through. The opposite hemisphere of the light-transmitting shell 138 is fitted with a plurality of therapeutic stones 154, such as small jade, quartz, tourmaline, or neodymium magnetic beads, without limitation, attached to or embedded in the surface. The opposite hemisphere of the light-transmitting shell 138, fitted with the plurality of therapeutic stones 154, when pressed against the skin, provides tactile massage stimulations and other stimulation therapies. The control board 134 may incorporate additional functions with the therapeutic stones 154: magnetic elements or coils behind the stones can generate a static magnetic field providing magnetotherapy, and microcurrent electrodes can deliver low-level electric currents. A thermoelectric Peltier element may be sandwiched beneath or attached to the stone-embedded hemisphere to heat or cool the therapeutic stones 154. The control board 134 can thus activate the therapeutic elements to provide hot or cold compress therapy on-demand and can energize the stones or electrodes under control according to the stimulations needed. The control switch 150 is configured to toggle between these states. When the control switch 150 is pressed and held for longer than a first preset time, the light-transmitting shell 138, the stone-embedded hemisphere, and the light-transmitting shell 138 phototherapy hemisphere enter the working state. Pressing and holding the control switch 150 again for longer than the first preset time switches the device to the off state, without limitation. When the control switch 150 is double-pressed quickly and held for longer than a first preset time, only the light-transmitting shell 138 stone-embedded hemisphere enters the working state. Pressing and holding the control switch 150 again for longer than the first preset time switches the device to the off state, without limitation. In this way, the user can roll the sphere so that either the translucent side for phototherapy or the stone side for massage therapy, magnetotherapy, thermal therapy, or microcurrent therapy contacts the skin, depending on treatment needs.

In an embodiment, the entire head 122 is covered by therapeutic stones 154. The sphere's outer surface is essentially one large mass of stones, and no direct light emanates from the head. Phototherapy is instead entirely provided by the rod 118 and its internal lamp board 136. The stone-covered sphere is used purely for massage, magnetotherapy, or hot/cold therapy: as the user rolls the sphere on their skin, the therapeutic stones 154 deliver pressure and any embedded stimuli such as magnetic fields for microcirculation enhancement and temperature changes via Peltier, without limitation. The Peltier element can be placed against the interior of the stone sphere to uniformly heat or cool it. Meanwhile, the control board 134 controls the lamp board 136 in the rod 118 to emit red and blue light through the rod 118 onto the skin. All elements, including the rod's LEDs, the Peltier, and any electronic elements in the sphere, are powered by the battery 144. When the control switch 150 is pressed and held for longer than a first preset time, the light-transmitting shell 138 and the rod 118 enter the working state. Pressing and holding the control switch 150 again for longer than the first preset time switches the device to the off state, without limitation. When the control switch 150 is double-pressed quickly and held for longer than a first preset time, only the light-transmitting shell 138 enters the working state. Pressing and holding the control switch 150 again for longer than the first preset time switches the device to the off state, without limitation. This embodiment allows the device to deliver massage and thermal or magnetic stimulation via the sphere and phototherapy via the rod, giving the user the benefits of all modalities in one apparatus.

In another embodiment, the light-emitting head comprises two concentric shells. An inner translucent shell is mounted on a rotatable ball joint, and an outer massage shell encloses it. The two shells are capable of relative rotation. The inner shell houses the lamp board 136 inside and transmits LED light outward. The outer shell may have a textured or stone-coated surface. By turning the locking mechanism, the user can rotate the inner shell independently, exposing different parts of the outer shell. For example, one semi-circle of the ball might be clear for light delivery, while the opposite semi-circle is studded with therapeutic stones 154 for massage. When rolled on skin, the user could flip the assembly to choose which side contacts the face. This configuration essentially allows more than one treatment mode from the spherical head; one side gives smooth phototherapy, while the other provides textured massaging. All electronics remain wired to the center, and the single control board 134 governs both shells.

In an embodiment, the phototherapy hairpin 100 is equipped with a wireless module, such as Bluetooth, without limitation, connected to the control board 134. The user can pair the device with a smartphone app, allowing remote control of all settings. For instance, the user could adjust light intensity, switch between red and blue, set the session duration, or toggle heating modes via the app's interface instead of the single button. The app can also display battery level, track usage history, and even remind the user to perform periodic therapy. All commands from the app are sent to the same control board 134, which integrates the wireless chipset. Thus, despite adding digital control, the device remains self-contained, powered by one board. This embodiment enhances usability and customization without changing the core hardware layout.

In an embodiment, adding one or more sensors to the skin-contacting surface 140 of the light-transmitting shell 138. A small pressure switch or capacitive touch sensor under the shell can detect when the head is pressed firmly against the skin. The control board 134 uses this feedback to ensure therapy only operates when in contact. Similarly, a built-in skin temperature sensor could monitor local temperature. The board could then modulate LED power or Peltier current to maintain a safe skin temperature, preventing overheating. For instance, if the Peltier is cooling the head, once the skin reaches a target temperature, the board might pause cooling. These sensors wire back to the same control board 134, providing closed-loop control of therapy parameters.

In some embodiments, the phototherapy hairpin 100 includes one or more sensors integrated into the skin-contacting surface 140 of the light-transmitting shell 138 to enhance safety and ensure proper operation. A pressure sensor or touch sensor may be disposed beneath or within the light-transmitting shell 138, configured to detect when the shell is pressed against the user's skin with sufficient pressure to establish effective contact. The sensor is electrically connected to the control board 134, which receives signals from the sensor indicating the contact state. The control board 134 is programmed to activate the lamp board 136 only when the sensor detects that the light-transmitting shell 138 is in firm contact with the skin, ensuring that therapeutic light is delivered only when the device is properly positioned for treatment. When the device is lifted away from the skin or contact pressure falls below a threshold level, the sensor signals the control board 134 to automatically deactivate the lamp board 136, thereby preventing unintended light emission into the surrounding environment. This contact-dependent activation feature significantly enhances safety, particularly when the device is used near sensitive areas such as the eyes, by minimizing the risk of accidental exposure to therapeutic light. The pressure sensor may be a capacitive touch sensor, a resistive pressure sensor, a piezoelectric sensor, or a mechanical switch configured to close a circuit when compressed. In some embodiments, the sensor may also provide feedback to the control board 134 regarding the magnitude of applied pressure, allowing the control board 134 to modulate light intensity or provide user feedback if pressure is insufficient for optimal treatment. The sensor-based activation system provides an additional layer of safety beyond manual control, reduces the likelihood of wasted battery power from inadvertent activation, and ensures that phototherapy is delivered only under appropriate conditions, thereby improving treatment efficacy and user confidence in device operation.

In some embodiments, the phototherapy hairpin 100 includes an overheating protection mechanism to prevent excessive temperature rise during operation and ensure user safety. A temperature sensor may be positioned adjacent to the lamp board 136, within the mounting cavity 106, or integrated into the light-transmitting shell 138 to monitor the temperature of critical components during use. The temperature sensor is electrically connected to the control board 134, which continuously or periodically reads temperature data from the sensor. The control board 134 is programmed with one or more temperature thresholds that, when exceeded, trigger protective actions to prevent overheating. For example, a first threshold may be set at approximately 45 degrees Celsius to protect the user's skin from burns or discomfort, while a second threshold may be set at approximately 60 degrees Celsius to protect internal electronic components from heat damage. If the temperature sensor detects that the temperature has reached or exceeded the predetermined threshold, the control board 134 automatically reduces power to the lamp board 136, activates cooling measures if available, or completely shuts down the device to allow cooling.

In an embodiment, the control board 134 may provide a warning to the user before shutting down, such as by flashing the power indicator light or emitting an audible alert, giving the user notice that the device is overheating. In addition to the temperature sensor and control board logic, the phototherapy hairpin 100 may include a thermal fuse or thermal cutoff device as a backup protection mechanism. The thermal fuse is a passive safety component that irreversibly or reversibly interrupts electrical current to the lamp board 136 or other heat-generating components if the temperature exceeds a critical safety limit, providing fail-safe protection even in the event of control board malfunction. After an automatic shutdown due to overheating, the device may be configured to remain disabled for a predetermined cooling period, such as 1 to 5 minutes, before allowing reactivation, ensuring that components have returned to a safe operating temperature. The overheating protection mechanism prevents skin burns, reduces the risk of fire or component damage, extends the operational lifespan of the device by avoiding thermal stress, and enhances user confidence in the safety and reliability of the phototherapy hairpin 100 during repeated use.

In some embodiments, the phototherapy hairpin 100 is configured to be charged via the charging plug 102 that magnetically couples to the charging port 114 of the hairpin body 104. The charging plug 102 comprises a plug body or housing that contains magnetic charging terminals configured to align with and magnetically attach to the magnetic electrode 146 within the charging port 114. The charging plug 102 includes one or more magnetic elements, such as permanent magnets or ferromagnetic materials, that generate magnetic attraction when brought into proximity with the magnetic electrode 146, causing the charging plug 102 to automatically align and attach to the charging port 114 without requiring precise manual positioning. The magnetic charging terminals of the charging plug 102 are positioned on the plug body to correspond with the exposed end of the magnetic electrode 146 within the charging port 114, establishing electrical contact when the plug is magnetically attached. A cable extends from the plug body of the charging plug 102 to connect to a power source, such as a USB adapter, computer USB port, or other standard power supply. The cable may be a USB cable, such as USB Type-A, USB Type-C, or micro-USB, enabling the user to charge the phototherapy hairpin 100 using widely available power sources. The magnetic attraction between the charging plug 102 and the magnetic electrode 146 eliminates the need for precise alignment or insertion of a connector, simplifying the charging process and reducing wear on electrical contacts. When the user brings the charging plug 102 near the charging port 114, the magnetic force automatically draws the plug into proper alignment and holds it securely in place during charging. The charging plug 102 may include an indicator light, such as an LED, that illuminates to show charging status, such as red or orange during charging and green when charging is complete. The detachable design of the charging plug 102 allows the user to charge the device conveniently and disconnect the plug when charging is complete or when the device is in use. The magnetic charging interface provided by the charging plug 102 and the magnetic electrode 146 enhances user convenience, prolong the lifespan of the charging interface by minimizing mechanical wear, and maintains the waterproof and dustproof integrity of the hairpin body 104 by eliminating the need for exposed charging ports or connectors.

In some embodiments, the light-transmitting shell 138 may have a diffusive or scattering optical surface configured to spread transmitted light into various angles and directions, thereby enhancing safety and improving light distribution characteristics. The diffusive surface may be prepared by forming micro-structures on the outer surface of the light-transmitting shell 138, such as fine grooves, dimples, or textured patterns, or by coating a layer of diffusive optical material on the shell surface. When the light-transmitting shell 138 is not in contact with the user's skin, the therapeutic light emitted by the lamp board 136 is diffused by the diffusive surface as it transmits through the shell into the surrounding air. This diffusion increases the spread angle of the transmitted light and reduces the light intensity when viewed from a distance, thereby enhancing the safety level of the phototherapy hairpin 100 by minimizing the risk of inadvertent exposure to concentrated light. In comparison, when the light-transmitting shell 138 is pressed firmly against the user's skin, the skin tissue in contact with the shell surface acts as an optical index-matching medium that effectively reduces the diffusing or scattering effect caused by the micro-structured surface. As a result, the light beam is efficiently delivered into the tissue with the desired direction, angle, power density, depth, and intensity distribution, ensuring effective phototherapy treatment. The diffusive surface thus provides a dual benefit: enhanced safety when the device is not in use or not in contact with skin, and effective light delivery when properly applied to the treatment area. In some embodiments, an optical index-matching medium, such as a gel, liquid, suspension, or powder, may be applied between the light-transmitting shell 138 and the user's skin to further enhance light transmittance and reduce light distortion caused by the shell surface. Such optical index-matching media may also possess therapeutic or pharmaceutical properties, such as moisturizing agents, anti-inflammatory compounds, or skin-soothing ingredients, thereby providing additional cosmetic or therapeutic benefits that complement the phototherapy treatment and improve overall treatment outcomes.

In one embodiment, the light-transmitting shell 138 is designed to be removable and interchangeable. For example, the head 122 may have a quick-release coupling so that the user can swap in light-transmitting shells 138 meant for different treatment needs. One shell might be a smooth jade ball for cooling massage, another might be a stone-studded ball for deep massage, a third could be an all-metal ball for heat conduction, etc. The control board 134 recognizes the type of head by a simple resistor and adjusts settings, without limitation. This modular approach lets users customize their device for different therapies. The ball joint base with the locking block 132 is reused; only the outer shell changes. The electronics and battery remain integrated in the handle.

In some embodiments, a user could press the control switch 150 to turn on red or blue LEDs and optionally activate stimulation elements; rolling the head applies those treatments across the skin. The control board 134 orchestrates the lamp board 136, the stimulation elements, and any electrodes or coils associated with therapeutic stones 154 according to user input from the control switch 150. The battery 144 supplies the required power to all these elements. Thus, the phototherapy hairpin 100 operates as an integrated multi-modal therapy device; the rod 118 and the head 122 serve as light therapy sources, the rolling motion provides massage, stimulation elements provide stimulation therapies, all in one handheld unit.

In some embodiments, the phototherapy hairpin 100 of the present invention provides combined therapeutic benefits that address the prior shortcomings. Its rolling spherical head allows the treatment surface to conform closely to facial or body contours, improving comfort and ensuring more uniform coverage compared to flat or fixed probes. Integrated dual phototherapy sources, the translucent rod 118 and the light-transmitting shell 138 of the spherical head 122, enable simultaneous red and blue light treatment over a larger area. Red light is known to stimulate fibroblasts and collagen production for skin repair, while blue light reduces acne-causing bacteria and sebum, yielding synergistic skin rejuvenation. In addition, the inclusion of therapeutic stones 154 for massaging and optional stimulations provided in the spherical head can enhance blood flow and reduce inflammation, further improving treatment outcomes. By integrating multiple stimulation modalities into one device, the phototherapy hairpin 100 simplifies skincare routines and enhances efficiency. For example, the light-transmitting shell 138 can freely roll on the skin surface to provide a gentle mechanical massage as the light or stones make contact. The stimulation elements in the head allow controlled stimulations, a technique known to alleviate pain and swelling, and used in many modern skin treatment devices. Embedded magnetic stones can generate localized magnetic fields to boost microcirculation, and microcurrent electrodes can provide gentle electrical stimulation. All of these elements are powered by the battery 144 and controlled by the single control board 134, which streamlines the user interface. The one-switch operation and simple power-indicator light further improve usability. The design is compact and balanced, making it lightweight, portable, and easy to handle for various therapeutic applications.

In some embodiments, the phototherapy hairpin 100 provides a unique dual-use advantage owing to its hairpin form factor. Unlike conventional phototherapy wands or facial devices that must be carried separately in a bag or case, the phototherapy hairpin 100 can serve both as a functional hairpin and as a phototherapy device. When not in use for therapy, the user can simply wear the device in their hair like a traditional hairpin, securing a hair bun or styling the hair while keeping the device readily accessible. This eliminates the need for a separate carrying case or dedicated bag space, as the device becomes an item of everyday use that is always available for treatment when needed. The hairpin form factor thus provides a convenient, discreet, and practical solution for users who wish to incorporate phototherapy into their daily routine without the burden of carrying additional devices.

In some embodiments, the head 122 of the phototherapy hairpin 100 may include a removable protective cover configured to prevent contamination of the light-transmitting shell 138 when the device is worn in the hair or stored. The protective cover may be formed from plastic, silicone, rubber, or other suitable material, and may be translucent or opaque. The protective cover detachably engages with the head 122, such as by snap-fit, friction fit, or threaded connection, and can be easily removed by the user when the device is to be used for phototherapy treatment. The protective cover maintains the hygiene of the skin-contacting surface 140 of the light-transmitting shell 138 by shielding it from dust, hair products, oils, and other contaminants that may accumulate when the device is worn in the hair. When the user wishes to perform phototherapy, the protective cover is removed to expose the light-transmitting shell 138, and after treatment, the cover may be replaced to protect the treatment surface until the next use. The protective cover may also protect the light-transmitting shell 138 from scratches or damage during storage or transport.

In some embodiments, the phototherapy hairpin 100 is configured for dual-mode operation depending on how the device is positioned. When the device is used to securely hold a hair bun, the rod 118 contacts the user's scalp, and the phototherapy unit disposed within the rod 118 can be activated to provide phototherapy to the scalp and hair follicles. In this hair bun mode, the device performs both a mechanical function of holding the hair bun in place like a normal hairpin and a therapeutic function of emitting controlled light to stimulate hair follicles, improve scalp circulation, reduce hair fall, promote hair growth, and treat scalp conditions such as dandruff, seborrheic dermatitis, or psoriasis. When the device is handheld by the user, the head 122 with the light-transmitting shell 138 can be applied to the face, neck, or other body regions where phototherapy is desired. In handheld mode, the device delivers phototherapy through the light-transmitting shell 138 for skin treatment applications such as acne reduction, wrinkle treatment, skin rejuvenation, and pain relief. The dual-mode operation is not limited to phototherapy, but may include other therapeutic modalities such as thermal therapy, magnetic therapy, microcurrent therapy, or massage, depending on the configuration of the device. This versatile design enables the phototherapy hairpin 100 to serve multiple treatment areas and purposes, providing scalp and hair therapy when worn in the hair and facial or body therapy when handheld, all within a single compact device.

In an embodiment, the control board 134 includes automatic control circuitry with sensors configured to detect whether the phototherapy hairpin 100 is positioned in the user's hair or held in the user's hand. The sensors may include capacitive sensors, proximity sensors, pressure sensors, or other suitable sensing elements capable of distinguishing between the two usage modes. For example, a capacitive sensor disposed on the rod 118 may detect the presence of the scalp when the device is worn in the hair, while a grip pressure sensor or orientation sensor may detect when the device is being handheld. Based on the sensor input, the control board 134 automatically activates the corresponding phototherapy unit. When the sensors detect that the device is worn in the hair, such as by sensing scalp contact via capacitive sensing, the control board 134 automatically activates the phototherapy unit in the rod 118 to deliver scalp treatment. When the sensors detect that the device is handheld, such as by sensing grip pressure or a particular orientation, the control board 134 automatically activates the phototherapy unit in the head 122 to deliver facial or body treatment. This automatic mode switching based on sensor input eliminates the need for the user to manually select the operating mode, enhancing convenience and ensuring that the appropriate therapy is delivered based on how the device is being used. The automatic control circuitry may also include safety features that prevent activation of the light sources when the device is not in contact with the user's body, thereby conserving battery power and preventing inadvertent light exposure.

In some embodiments, the rod 118 further includes a distal tip 156 positioned at an end of the rod 118 opposite the head 122, which may house a storage unit configured to store serum, cosmetic formulation, medication, or other therapeutic substance. The storage unit may comprise a reservoir, cartridge, or chamber disposed within the distal tip 156 of the rod 118, with a dispensing opening or nozzle at the distal tip 156 through which the stored contents can be dispensed onto the user's skin during treatment. The dispensing may be manual, such as by squeezing a flexible portion of the distal tip 156 or pressing a dispensing button, or may be controlled by the control board 134, such as through a motorized pump or valve. This configuration allows the user to combine phototherapy treatment with topical application of active ingredients, enhancing therapeutic efficacy by delivering serums, medications, or cosmetics directly to the treatment area while simultaneously applying light therapy. The storage unit may be refillable, allowing the user to replenish the contents when depleted, or may be replaceable as a cartridge that can be swapped for a fresh supply. The combination of phototherapy with topical substance delivery provides synergistic treatment benefits, as the light therapy may enhance absorption of the topical substance into the skin, and the topical substance may complement the effects of the phototherapy.

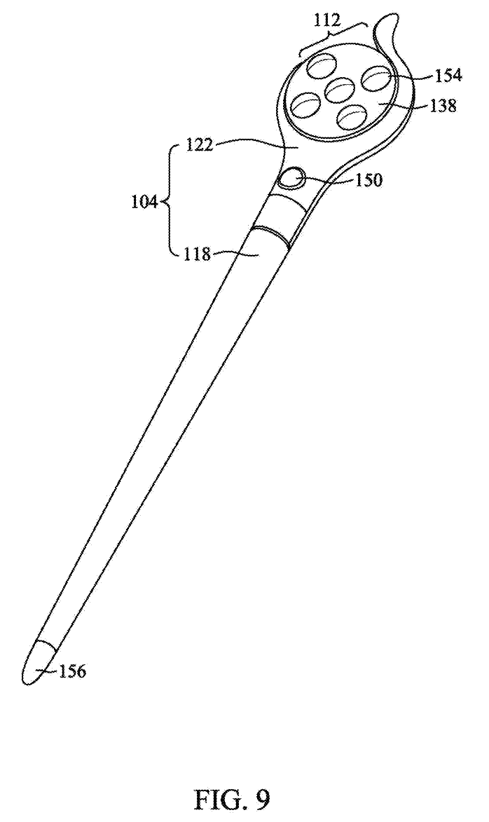

Referring to FIGS. 8 and 9, in an embodiment, a third stimulation element 158 is disposed at the distal tip 156 and is configured to provide a localized therapeutic or stimulation effect when the distal tip 156 contacts a target area of the scalp or skin. The third stimulation element 158 may be selected from the group of stimulation elements including, but not limited to, a phototherapy element, a microcurrent element, a Peltier element, a vibrational element, a thermal element, an ultrasonic wave therapy element, a magnetotherapy element, electrical stimulation elements, galvanic element, Tens element, RF element, a pulsed electromagnetic field (PEMF) element or a combination thereof. In an embodiment, the third stimulation element 158 operates independently of, or in coordination with, the first stimulation element provided in the head 122 and the second stimulation element 152 to provide multi-point or multi-modal therapy under the control of the control board 134.

In this configuration, the phototherapy hairpin 100 has a first stimulation element disposed at the head 122, such as the light-transmitting shell 138 with phototherapy and massage functions, the second stimulation element 152 disposed along the length of the rod 118, and the third stimulation element 158 disposed at the distal tip 156 of the rod 118. This multi-stimulation arrangement enables multi-point stimulation therapy, wherein the user can apply different therapies to different areas simultaneously or sequentially. For example, the user may apply phototherapy and massage via the head 122 to the face while simultaneously delivering microcurrent stimulation via the distal tip 156 of the rod 118 to a specific acupressure point or treatment area. All of the stimulation elements are electrically connected to and controlled by the single control board 134, which coordinates their operation and allows the user to select activation of either or both stimulation elements through the control switch 150 or a connected application. The third stimulation element 158 at the distal tip 156 expands the therapeutic versatility of the phototherapy hairpin 100, enabling targeted treatment of multiple areas or application of complementary therapies in a single treatment session.

In some embodiments, when the phototherapy hairpin 100 is worn in the user's hair, the control board 134 may be configured to selectively activate only the portion of the rod 118 that is covered by the hair, while keeping the portions of the rod 118 that are exposed outside the hair inactive. This selective activation maintains the aesthetic appearance of the device when worn, as the therapeutic light is emitted only beneath the hair where it contacts the scalp, and is not visible to others. Sensors disposed along the length of the rod 118, such as light sensors, capacitive sensors, or proximity sensors, may detect which portions of the rod 118 are covered by hair and which portions are exposed to ambient light or air. The control board 134 receives signals from these sensors and activates only the light strip or phototherapy elements in the covered portions of the rod 118, while the light strip in the exposed portions remains off. This selective activation ensures that the phototherapy hairpin 100 looks cosmetically acceptable when worn in the hair, without visible light emission that might be noticeable or distracting to others. The selective activation feature also conserves battery power by illuminating only the portions of the rod 118 that are in contact with the scalp and capable of delivering effective therapy, rather than wasting energy on light emission that would not reach the treatment area.

In some embodiments, the light-transmitting shell 138 configured as a roller ball may be disposed on a single side of the head 122, providing a focused treatment area on one side of the device. Alternatively, roller balls may be disposed on both sides of the head 122, with each roller ball covering a respective end of the light emission hole 108 and the lamp board 136 positioned between the two roller balls. The single-side configuration provides a focused treatment area and may be preferred for targeted therapy on specific facial regions, while the dual-side configuration enables simultaneous treatment of both sides or allows the user to quickly switch between sides without repositioning the device. In the dual-sided configuration, both roller balls may be independently rotatable, allowing each to conform to the skin contours on its respective side. Both configurations allow rolling massage with simultaneous phototherapy, as the roller balls transmit light from the lamp board 136 while providing mechanical massage through their rolling motion across the skin surface.

In some embodiments, the light emitted from the rod 118 is effective for multiple therapeutic applications beyond facial skin treatment. For hair treatment, the light from the rod 118 stimulates hair follicles, promotes hair growth, and may help reduce hair fall by improving cellular metabolism in the scalp. For scalp treatment, the light improves blood circulation in the scalp and may be effective for treating conditions such as dandruff, seborrheic dermatitis, psoriasis, and other scalp disorders. For pain relief, the light from the rod 118 may reduce muscle tension and relieve headaches when applied to the temples, forehead, or neck region. The rod 118 phototherapy thus extends the treatment capabilities of the phototherapy hairpin 100 beyond facial applications, enabling the device to serve as a versatile therapeutic tool for hair care, scalp health, and pain management, all controlled by the single control board 134 and powered by the battery 144.

In some embodiments, the rod 118 and the head 122 are detachably connected, and the attachment means may include various mechanisms for securing the rod 118 to the head 122. In one embodiment, the attachment means comprises a magnetic attachment, wherein magnets disposed in the rod 118 and corresponding magnets or ferromagnetic elements disposed in the head 122 provide a secure yet easily separable connection through magnetic attraction. The magnetic attachment enables quick, tool-free assembly and disassembly of the rod 118 and the head 122, and provides satisfying tactile feedback when the components connect. The magnetic connection is strong enough to maintain secure attachment during normal use, yet can be easily separated when the user desires to disassemble the device for cleaning, maintenance, or component replacement. In other embodiments, the attachment means may include snap-fit connections, threaded connections, bayonet mounts, locking tabs, or the locking block 132 and the locking hole 120 arrangement described herein. The detachable connection between the rod 118 and the head 122, regardless of the specific attachment means employed, facilitates modular assembly, disassembly, cleaning, and component replacement, enhancing the maintainability and versatility of the phototherapy hairpin 100.

In some embodiments, the phototherapy hairpin 100 is configured to function both as a traditional hairpin for securing hair and as a phototherapy device for therapeutic treatment. The rod 118 has a tapered or pointed distal end configured to pierce through and secure a hair bun or other hair arrangement, similar to a conventional decorative hairpin. The rod 118 has sufficient length, for example, in the range of 80 mm to 150 mm, and sufficient structural rigidity to hold hair securely in place during normal activities. The head 122 serves as a decorative end piece that remains visible when the device is worn in the hair, while internally housing the phototherapy components, including the lamp board 136, the control board 134, and the light-transmitting shell 138. The weight distribution between the rod 118 and the head 122 is balanced to ensure comfortable wearing for extended periods, with the head 122 being heavier due to the internal components but not so heavy as to cause the device to slip or pull on the hair. The outer surfaces of the rod 118 and the head 122 are formed from smooth, non-reactive materials suitable for contact with hair and scalp, such as medical-grade plastics, polished metals, or coated surfaces that do not snag or damage hair. The device can transition between a hair-worn mode, in which it functions as a hairpin while optionally delivering scalp therapy, and a handheld treatment mode, in which the user grips the rod 118 and applies the head 122 to the skin for phototherapy, without any modification or reconfiguration of the device. This dual-use capability eliminates the need for users to carry a separate phototherapy device, as the phototherapy hairpin 100 serves as an everyday accessory that is always available for therapeutic use when desired.

In some embodiments, the phototherapy hairpin 100 comprises a first stimulation element disposed in the head 122 and a second stimulation element 152 disposed in the rod 118, enabling dual-mode operation for different treatment applications. The first stimulation element comprises the lamp board 136 positioned within the mounting cavity 106 of the head 122, with LEDs configured to emit therapeutic light outwardly through the light-transmitting shell 138 for facial or body skin treatment. The second stimulation element 152 comprises a light strip with an array of LEDs disposed along the length of the rod 118 beneath a translucent outer layer formed from thermoplastic polyurethane TPU or polyurethane PU. The LED array in the rod 118 may be arranged in a linear array extending along the longitudinal axis of the rod 118, or in a helical pattern wrapping around the rod circumference, to provide uniform light distribution along the rod length. The LEDs in the rod 118 emit light radially outward through the translucent outer layer to contact the user's scalp when the device is worn in the hair. The control board 134 independently controls the first stimulation element in the head 122 and the second stimulation element in the rod 118, allowing selective activation of either or both units depending on the treatment mode. In a hair bun mode, when the device is worn in the hair to secure a bun, the control board 134 activates the second stimulation element 152 in the rod 118 to deliver phototherapy to the scalp for hair follicle stimulation, increased blood circulation, reduced inflammation, neuro-treatment, stress relieving, and antibacterial treatment of scalp conditions. In a handheld mode, when the user grips the rod 118 and applies the head 122 to the skin, the control board 134 activates the first stimulation element in the head 122 to deliver phototherapy through the light-transmitting shell 138 for facial or body treatment.

In an embodiment, the control board 134 includes automatic sensing and control circuitry configured to detect the usage mode of the phototherapy hairpin 100 and automatically activate the appropriate phototherapy unit without requiring manual mode selection by the user. The sensing circuitry comprises one or more sensors disposed on or within the hairpin body 104 and electrically connected to the control board 134. A capacitive touch sensor may be disposed on the surface of the rod 118, comprising a conductive electrode layer beneath the rod's outer surface connected to a capacitance measurement circuit on the control board 134, configured to detect proximity or contact with the user's scalp based on changes in capacitance when the rod approaches or contacts skin or hair. A grip pressure sensor, which may be a piezoelectric sensor or a resistive pressure sensor, may be disposed within the rod 118 to detect when the user is gripping the rod in a handheld manner based on the pressure applied to the rod surface. Handheld grip may be detected when the output of the grip pressure sensor exceeds a threshold value, indicating that the user is holding the device. The control board 134 executes control logic that selects the operating mode based on the sensor inputs: when scalp contact is detected, the control board 134 activates the phototherapy unit in the rod 118; when a handheld grip is detected, the control board 134 activates the phototherapy unit in the head 122. The user may override the automatic mode selection via the control switch 150 if manual control is desired.

In some embodiments, providing concrete mode-selection, the one or more sensors comprise at least a capacitive proximity electrode disposed along the rod surface, one or more pressure or force sensors embedded beneath the rod outer layer, and a 3-axis inertial sensor. The capacitive sensor is configured to report a relative capacitance change ΔC referenced to an ambient baseline. When ΔC exceeds a threshold, for example, more than 20 per cent above baseline, the control board will register scalp proximity without limitation. Grip detection is confirmed when the pressure sensor reports a sustained force above a configurable threshold, for example, more than 0.5 N over 100 ms, while the inertial sensor reports grip-like orientation, for example, pitch within ±30 degrees of the handheld orientation. The control board implements a simple decision tree with hysteresis and a 200-500 ms debounce period, if scalp proximity is confirmed and grip is not confirmed, the board enters hair-mode and activates the rod 118 stimulation elements; if grip is confirmed and scalp proximity is not confirmed, the board enters handheld-mode and activates the head stimulation element; if both conditions are simultaneously true the board defers to the last stable mode or invokes a default safe mode as no stimulation until one condition persists for a configurable hold time, for example for 1 s. The thresholds and timings are provided as representative implementation values and may be adjusted in firmware to suit different sensor implementations100 mA.

In some embodiments, the distal tip 156 of the rod 118, opposite from the head 122, houses a storage unit configured to store and dispense a therapeutic substance such as serum, cosmetic formulation, medication, or other active ingredient. The storage unit comprises a reservoir or chamber disposed within the distal tip 156 of the rod 118, having a volume sufficient to hold multiple treatment doses of the therapeutic substance. The reservoir walls may be formed from a flexible silicone bladder that can be squeezed to expel contents, or from a rigid plastic cartridge with a piston or pump mechanism. One or more dispensing apertures are formed at the distal tip 156 end of the rod 118 to allow the therapeutic substance to be dispensed onto the user's skin during treatment. The dispensing mechanism may be manual, wherein the user squeezes a flexible portion of the distal tip 156 to expel the contents through the dispensing apertures, or presses a dispensing button that advances a spring-loaded piston to push the contents out. Alternatively, the dispensing mechanism may be electronic, comprising a micro-pump controlled by the control board 134 and activated via the control switch 150 or a connected smartphone application. The storage unit may be refillable through a removable tip cap having a threaded or snap-fit closure that provides access to the reservoir for adding more therapeutic substance when depleted. Alternatively, the entire distal tip 156 may be detachable and replaceable as a cartridge, allowing the user to swap in a fresh cartridge containing a different therapeutic substance or a refilled supply. The dispensing of the therapeutic substance may be synchronized with activation of the phototherapy unit, allowing the user to apply the substance to the skin and immediately follow with light therapy to enhance absorption and efficacy of the active ingredients.

In some embodiments, the distal tip 156 end of the rod 118 includes the third stimulation element 158 configured to deliver therapeutic stimulation independently of or in conjunction with the phototherapy and massage functions of the head 122. The third stimulation element 158 is disposed at the distal end of the rod 118, opposite from the head 122, and is electrically connected to the control board 134 via wires routed through the interior of the rod 118. The third stimulation element 158 may comprise one or more of the following: microcurrent electrodes formed from a pair of conductive elements, such as gold-plated contacts, stainless steel pads, or conductive polymer surfaces, configured to deliver microcurrent stimulation at a current level in the range of 10 microamperes to 600 microamperes with a pulsed or continuous waveform at a frequency in the range of 0.5 Hz to 10 Hz; a vibration motor, such as an eccentric rotating mass motor or a linear resonant actuator, operating at a frequency in the range of 50 Hz to 200 Hz to provide vibratory massage stimulation; a thermal element, such as a resistive heater or a Peltier thermoelectric device, configured to heat the distal tip 156 to a temperature in the range of 38°C to 45°C for warming therapy or to cool the distal tip 156 to a temperature in the range of 10°C to 20°C for cooling therapy; or an ultrasonic transducer comprising a piezoelectric element operating at a frequency in the range of 1 MHz to 3 MHz for deep tissue penetration and enhanced product absorption. The control board 134 can activate the third stimulation element 158 at the distal tip 156 independently of the stimulation elements at the head 122, or can activate both simultaneously to provide multi-point stimulation therapy. The user may select the desired stimulation mode through the control switch 150, which cycles through available modes, including head only, distal tip 156 only, both head and distal tip 156, and off. Safety features implemented by the control board 134 include current limiting for microcurrent electrodes, temperature monitoring, and automatic shutoff for thermal elements, and contact detection to prevent activation when the distal tip 156 is not in contact with skin.

In some embodiments, when the phototherapy hairpin 100 is worn in the user's hair, the control board 134 implements selective activation of the phototherapy elements in the rod 118 to maintain an aesthetically acceptable appearance by preventing visible light emission from portions of the rod that are exposed outside the hair. The rod 118 contains multiple independently addressable LED strips disposed along its length, with each strip comprising one or more LEDs that can be activated or deactivated independently by the control board 134. The rod 118 may contain, for example, 3 to 10 LED strips, with each strip containing 1 to 5 LEDs, distributed along the length of the rod from the head 122 toward the tip 156. Each LED strip is connected to a separate control channel on the control board 134, allowing individual control of each strip. Strip detection sensors are disposed adjacent to each LED strip to detect whether that strip is covered by hair or exposed to the ambient environment. The strip detection sensors may comprise ambient light sensors, such as photodiodes, that detect the light level adjacent to each strip, with the covered strip showing low ambient light levels due to shading by the hair and the exposed strip showing higher ambient light levels. Alternatively, the strip detection sensors may comprise capacitive proximity sensors that detect the presence of hair or scalp near each segment of the light strip based on capacitance changes. The control board 134 executes a detection algorithm that determines, for each strip, whether the strip is covered or exposed based on the sensor readings. The control board 134 activates only those light strips determined to be covered by hair, while keeping the exposed light strip inactive. This selective activation ensures that therapeutic light is emitted only where it can contact the scalp and provide therapeutic benefit, while no light is emitted from exposed portions of the rod that would be visible to others. The system continuously monitors the sensors and adjusts the active light strip in real time as the position of the hair changes, ensuring that the device always maintains an aesthetically acceptable appearance while maximizing therapeutic delivery to the covered scalp areas.

In some embodiments, the light-transmitting shell 138 is configured as a rotatable roller ball that may be disposed on a single side of the head 122 or on both sides of the head 122. In a single-sided roller configuration, one spherical light-transmitting shell 138 is mounted on one side of the head 122, retained in a socket or partial enclosure that allows the ball to rotate freely while preventing the ball from detaching from the head. The lamp board 136 is positioned within the head 122 to direct therapeutic light through the single roller ball. The opposite side of the head 122 may be flat, may have a non-rolling treatment surface, or may be configured for a different function. In a dual-sided roller configuration, two spherical light-transmitting shells 138 are mounted on opposite sides of the head 122, with each ball covering a respective end of the light emission hole 108 that extends through the head. The lamp board 136 is positioned between the two balls, with LEDs on both sides of the lamp board substrate emitting light in opposite directions through the respective balls. Each ball is independently rotatable in its respective socket, allowing each ball to conform to the skin contours on its respective side without affecting the rotation of the other ball. The user can treat two areas simultaneously by pressing both sides of the head against the skin, or can flip the device to use either side as preferred.

In some embodiments, the therapeutic light emitted from the rod 118 is configured for multiple therapeutic applications, including hair treatment, scalp treatment, and pain relief. For hair treatment applications, the rod 118 emits red light at a wavelength of approximately 630 nm, which penetrates 2 mm to 3 mm into the scalp tissue to reach the hair follicles and stimulate mitochondrial activity in the follicle cells, increasing ATP production and prolonging the anagen growth phase of the hair cycle to promote hair growth and reduce hair fall. For antibacterial scalp treatment, the rod 118 emits blue light at a wavelength of approximately 415 nm, which provides antibacterial action against scalp microorganisms, including bacteria that cause folliculitis and contribute to dandruff, and which may also help reduce sebum production in the scalp. In some embodiments, the rod 118 may additionally emit near-infrared light at a wavelength of approximately 850 nm, which penetrates deeper into the tissue, in the range of 5 mm to 10 mm, for enhanced stimulation of hair follicles and increased blood circulation in the scalp. The power density of the therapeutic light at the scalp surface is in the range of 10 mW/cm² to 40 mW/cm² to provide a therapeutic effect. The therapeutic mechanisms for scalp treatment include increased blood flow to the hair follicles through vasodilation, increased delivery of oxygen and nutrients to the follicle cells, reduced production of inflammatory cytokines to decrease scalp irritation and inflammation, and photodynamic inactivation of bacteria through the generation of reactive oxygen species. For pain relief applications, the red and near-infrared light emitted from the rod 118 may be applied to the temples, forehead, or neck region to reduce muscle tension, increase local circulation, and relieve headaches and neck pain through the same photobiomodulation mechanisms. Treatment protocols for different applications may be stored in memory on the control board 134 and selectable by the user via the control switch 150, with different protocols specifying the wavelength combination, power level, and treatment duration appropriate for hair growth, scalp health, or pain relief applications.

In some embodiments, the lamp board 136 may operate in a continuous wave mode wherein the LEDs emit light continuously during treatment, or in a pulsed mode wherein the LEDs emit light in pulses at a frequency in the range of 1 Hz to 1000 Hz. Pulsed light modes may enhance therapeutic efficacy by allowing tissue relaxation between pulses, reducing thermal buildup, and potentially improving cellular response through specific pulse frequencies. The duty cycle of the pulsed light may be adjustable in the range of 10% to 90%, allowing customization of the treatment intensity. The control board 134 may store multiple treatment protocols with predefined wavelength combinations, pulse frequencies, duty cycles, and treatment durations, such as an acne protocol using blue light at 415 nm for 3 minutes, an anti-aging protocol using red light at 630 nm for 5 minutes, and a hair growth protocol using red light at 630 nm combined with near-infrared light at 850 nm for 10 minutes.

In some embodiments, the phototherapy hairpin 100 is compatible with wireless charging using the Qi wireless charging standard or similar inductive charging technology. A wireless charging receiver coil may be disposed within the head 122 or the rod 118 of the hairpin body 104, the receiver coil being electrically connected to a charging circuit on the control board 134. The user may place the phototherapy hairpin 100 on a Qi-compatible wireless charging pad or stand, and the charging pad transmits power wirelessly to the receiver coil to charge the battery 144.

In use, a method of providing therapy using the phototherapy hairpin 100 comprises the following steps. The user may secure the phototherapy hairpin 100 in the hair by inserting the rod 118 into a hair bun or other hair arrangement, wherein the rod 118 contacts the scalp of the user. Alternatively, the user may hold the phototherapy hairpin 100 in the hand by gripping the rod 118 and applying the head 122 to the skin. The one or more sensors continuously monitor the usage context and detect whether the phototherapy hairpin 100 is secured in the hair of the user or held in the hand of the user. The detection may be performed by sensing at least one of: a capacitance change indicative of scalp proximity, wherein the capacitive sensor detects the presence of scalp tissue in proximity to the rod 118; a pressure indicative of grip or hair contact, wherein the pressure sensor detects lateral pressure from surrounding hair or grip pressure from the user's fingers; an orientation of the phototherapy hairpin 100, wherein the accelerometer or gyroscope detects a generally horizontal orientation indicating the device is worn in hair versus a variable orientation indicating handheld use; or an ambient light level, wherein the ambient light sensor detects a dark environment indicating the rod 118 is inside a hair bun versus a brighter environment indicating the device is exposed. When one or more sensors detect that the phototherapy hairpin 100 is secured in the hair of the user, the control board 134 automatically activates the second stimulation element 152 disposed on the rod 118 to provide a second therapeutic effect to the scalp of the user. The second therapeutic effect may include phototherapy to stimulate hair follicles, improve scalp circulation, reduce hair fall, and promote hair growth. The control board 134 may selectively activate only those light strips of the rod 118 that are covered by hair, based on input from one or more sensors, while maintaining inactive those light strips that are exposed outside the hair to preserve aesthetic appearance. When one or more sensors detect that the phototherapy hairpin 100 is held in the hand of the user, the control board 134 automatically activates the first stimulation element disposed on the head 122 to provide a first therapeutic effect. The first therapeutic effect may include phototherapy and massage to the face, neck, or other body area for skin rejuvenation, acne treatment, anti-ageing, or pain relief. The method may further comprise dispensing a substance from a storage chamber disposed at the distal tip 156 of the rod 118 onto the scalp of the user while providing the third therapeutic effect. The substance may be dispensed manually by the user squeezing the tip 156, mechanically by pressing a dispensing button, or electronically by the control board 134 activating a micro-pump. The dispensed substance, such as a hair growth serum or scalp treatment, acts synergistically with the phototherapy to enhance absorption and therapeutic efficacy. The method may further comprise providing a third therapeutic effect to the scalp via the third stimulation element 158 disposed at the distal tip 156 of the rod 118. The third therapeutic effect may comprise at least one of: microcurrent stimulation to stimulate hair follicles and promote cellular activity; vibration to improve scalp circulation and provide massage; thermal therapy to enhance blood flow and relax muscles; or ultrasonic stimulation to enhance product absorption and provide deep tissue treatment. The control board 134 coordinates the activation of the first, second, and third stimulation elements based on the detected usage mode and user-selected treatment protocol, providing comprehensive, convenient, and effective multi-modal therapy.

In some embodiments, the control board 134 includes automatic control circuitry with one or more sensors configured to detect whether the phototherapy hairpin 100 is positioned in the user's hair or held in the user's hand, and to automatically activate the corresponding phototherapy unit without requiring manual mode selection by the user. The sensors may include one or more of the following types: capacitive touch sensors comprising conductive electrode layers disposed beneath the outer surface of the rod 118 and connected to a capacitance measurement circuit on the control board 134, which detect the presence of human tissue such as scalp or fingers by measuring changes in capacitance; skin-contact conductivity sensors that detect the electrical conductivity of skin to distinguish between scalp contact and open air; force-sensitive resistors or pressure sensors that detect pressure exerted on the rod 118, wherein bun insertion creates lateral pressure from the surrounding hair mass while handheld grip creates a different localized pressure pattern; accelerometers or gyroscopes disposed on the control board 134 that detect the orientation and motion of the device, wherein an inserted pin is mostly stationary and generally horizontal while handheld use exhibits dynamic movement patterns; optical proximity sensors comprising an infrared emitter and photodetector pair that detect the presence of hair or scalp nearby by measuring reflected infrared light; and ambient light sensors comprising photodiodes that measure the ambient illumination level, wherein the interior of a hair bun is darker than the external environment. The control board 134 executes a detection algorithm that processes the sensor inputs and determines the current mode of use based on predetermined thresholds, such as activating the rod phototherapy unit when capacitance exceeds a scalp-contact threshold or when ambient light falls below a darkness threshold indicating the rod is inside a hair bun. Hysteresis and debouncing logic may be implemented to prevent mode oscillation when sensor readings are near threshold values. The user may override the automatic mode selection via the control switch 150 if manual control is desired.

The phototherapy hairpin 100 of the present invention has broad industrial applicability in the personal care, beauty, and healthcare industries. The device may be manufactured using conventional manufacturing processes, including injection molding for plastic components, printed circuit board assembly for electronic components, and standard battery and LED assembly techniques. The phototherapy hairpin 100 may be marketed and sold as a consumer personal care device for home use, enabling users to perform phototherapy treatments for hair growth, scalp health, skin rejuvenation, acne treatment, and pain relief without visiting a clinic or salon. The device may also be utilized in professional settings such as hair salons, beauty spas, dermatology clinics, and trichology centers, where practitioners can provide phototherapy treatments to clients as part of hair restoration, scalp treatment, or facial rejuvenation services. The compact, portable, and dual-function design of the phototherapy hairpin 100 enables integration of therapeutic treatment into daily routines, improving treatment compliance and therapeutic outcomes. The modular construction and interchangeable components facilitate maintenance, repair, and customization for different treatment applications, supporting a sustainable product lifecycle. The phototherapy hairpin 100 thus addresses a significant market need for convenient, effective, and discreet phototherapy devices that combine the functionality of a hair accessory with multi-modal therapeutic capabilities.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

What is claimed is:

1. A phototherapy hairpin, comprising:
a hairpin body configured to secure and tie hair of a user, a hairpin body having a mounting cavity at one end and a light emission hole communicating with the mounting cavity;
a control board disposed within the mounting cavity;
a lamp board disposed within the mounting cavity and electrically connected to the control board, the lamp board configured to emit light; and
a light-transmitting shell mounted on the hairpin body and covering the light emission hole, wherein light emitted by the lamp board passes through the light-transmitting shell to irradiate outwardly, and wherein the light-transmitting shell is configured to contact human skin for massage,
wherein the light-transmitting shell serves a dual function of delivering controlled phototherapy and providing a massage surface, when the phototherapy hairpin is either held in a hand of a user or positioned in contact with skin of the user.

2. The phototherapy hairpin of claim 1, wherein the light emission hole penetrates through the hairpin body, and wherein the phototherapy hairpin comprises two light-transmitting shells respectively covering opposite ends of the light emission hole, the lamp board being positioned between the two light-transmitting shells.

3. The phototherapy hairpin of claim 1, wherein the light-transmitting shell comprises a jade massage block.

4. The phototherapy hairpin of claim 1, wherein the light-transmitting shell has a skin-contacting surface exposed outside the hairpin body, the skin-contacting surface being an outwardly convex arc surface.

5. The phototherapy hairpin of claim 1, wherein the hairpin body comprises a limiting strip surrounding the light emission hole, the limiting strip abutting against a side wall of the light-transmitting shell, and wherein the limiting strip has a notch exposing a portion of the side wall of the light-transmitting shell.

6. The phototherapy hairpin of claim 1, further comprising:
a battery disposed within the hairpin body and electrically connected to the control board;
a charging port formed in the hairpin body; and
a magnetic electrode having one end electrically connected to the control board and another end extending into the charging port, wherein the magnetic electrode is configured to magnetically couple with a charging plug.

7. The phototherapy hairpin of claim 1, wherein the hairpin body comprises a rod and a head detachably connected to the rod, the head having the mounting cavity and the light emission hole, wherein a diameter of the head is larger than a diameter of the rod.

8. The phototherapy hairpin of claim 7, wherein the rod and the head are detachably connected by at least one of: a locking block on one of an outer wall of the rod and an inner wall of the head engaged with a locking hole on the other; or magnetic attachment wherein magnets disposed in the rod and the head provide magnetic attraction for connection.

9. A phototherapy hairpin for dual-mode operation, comprising:
a head comprising a mounting cavity and a first stimulation element disposed within the mounting cavity, the first stimulation element being configured to provide a first therapeutic effect;
a rod having a first end and coupled to the head and a distal tip configured to engage hair of a user when the phototherapy hairpin is worn, and to be gripped by the user when the phototherapy hairpin is held in the hand, the rod comprising a second stimulation element configured to provide a second therapeutic effect;
wherein the rod is configured to attached with the head;
one or more sensors configured to detect whether the phototherapy hairpin is secured in the hair of the user or held in hand of the user; and
a control board electrically connected to the first stimulation element, the second stimulation element and the one or more sensors, the control board configured to automatically activate the first stimulation element when the one or more sensors detect that the phototherapy hairpin is held in the hand of the user, and to activate the second stimulation element when the one or more sensors detect that the phototherapy hairpin is secured in the hair of the user.

10. The phototherapy hairpin of claim 9, wherein the head further comprising a light-transmitting shell having a single spherical roller ball rotatably mounted on one side of the head, the roller ball configured to roll on the skin while transmitting therapeutic light.

11. The phototherapy hairpin of claim 10, wherein the head includes a removable protective cover configured to cover the light-transmitting shell when the phototherapy hairpin is secured in the hair or stored.

12. The phototherapy hairpin of claim 9, wherein the head comprises two spherical roller balls rotatably mounted on opposite sides of the head, each roller ball configured to roll on the skin while transmitting therapeutic light.

13. The phototherapy hairpin of claim 9, wherein the distal tip of the rod comprises a second stimulation element configured to provide therapy to the scalp when the phototherapy hairpin is secured in the hair, the second stimulation element comprising at least one of: a microcurrent electrode, a vibration motor, a thermal element, or an ultrasonic transducer.

14. The phototherapy hairpin of claim 9, wherein the distal tip of the rod comprises a storage chamber configured to store and dispense a substance onto the scalp of the user, the substance comprising at least one of: a serum, a medication, a hair growth formulation, or a cosmetic formulation.

15. The phototherapy hairpin of claim 9, wherein the one or more sensors comprise at least one of: a capacitive sensor, a pressure sensor, an accelerometer, a gyroscope, an optical proximity sensor, or an ambient light sensor.

16. The phototherapy hairpin of claim 9, wherein the rod comprises a plurality of independently addressable light strips , and wherein the control board is configured to selectively activate only those light strips that are covered by hair based on input from the one or more sensors.

17. A method of providing phototherapy using a phototherapy hairpin comprising a head having a first stimulation element, and a rod having a second stimulation element, the method comprising:
detecting, by one or more sensors, whether the phototherapy hairpin is secured in the hair of a user or held in a hand of the user;
when the one or more sensors detect that the phototherapy hairpin is secured in the hair of the user:
activating, by a control board, the second stimulation element disposed on the rod to provide a second therapeutic effect to the scalp of the user; and
when the one or more sensors detect that the phototherapy hairpin is held in the hand of the user:
activating, by the control board, the first stimulation element to provide a first therapeutic effect.

18. The method of claim 17, wherein detecting whether the phototherapy hairpin is secured in the hair or held in the hand comprises sensing at least one of: a capacitance change indicative of scalp proximity, a pressure indicative of grip or hair contact, an orientation of the phototherapy hairpin, or an ambient light level.

19. The method of claim 17, further comprising dispensing a substance from a storage chamber disposed at the distal tip of the rod onto the scalp of the user while providing scalp phototherapy.

20. The method of claim 17, further comprising providing a second stimulation therapy to the scalp via a stimulation element disposed in the rod, the second stimulation therapy comprising at least one of: microcurrent stimulation, vibration, thermal therapy, or ultrasonic stimulation.
